(19) United States
(12) Patent Application Publication
(10) Pub. No.: US 2026/0229999 A1
(43) Pub. Date: Aug. 6, 2026

(54) SINGLE-STAGE POWER CONVERSION DEVICE AND INDUCTOR ASSEMBLY

(71) Applicant: MetaPWR Electronics Co., Ltd., Shanghai (CN)

(72) Inventors: Da Jin, Shanghai (CN); Yahong Xiong, Shanghai (CN)

(73) Assignee: MetaPWR Electronics Co., Ltd., Shanghai (CN)

(21) Appl. No.: 19/530,339

(22) Filed: Feb. 5, 2026

(30) Foreign Application Priority Data
Feb. 6, 2025 (CN) 202510132410.X
May 7, 2025 (CN) 202510581204.7

(51) Int. Cl. H02M 3/335; H01F 27/30; H02M 1/00

(52) U.S. Cl. CPC H02M 3/33592; H01F 27/306; H02M 1/0043

(57) ABSTRACT

The present application discloses a power conversion circuit with high power requirements. The primary-side circuit uses two groups of full-bridge circuits or half-bridge circuits in parallel architecture, and the secondary-side circuit uses N synchronous rectifier units and N inductors, N is a natural number of multiples of 4; by adding the auxiliary winding coupled to the inductor, the N auxiliary windings and the series inductor are connected in series to form a closed loop, so as to obtain higher conversion efficiency and power density, and improve the response capability to rapid transition of the load. On the other hand, the present application provides a power conversion device, which reduces the volume of the power conversion device by means of the component arrangement and a winding manner and structure design of a transformer assembly and an inductor assembly, thereby improving the load dynamic performance of the power conversion device.

### CROSS-REFERENCE TO RELATED APPLICATION

This application claims the priority benefit of Chinese patent application CN202510132410.X filed on Feb. 6, 2025 and Chinese patent application CN202510581204.7 filed on May 7, 2025. The entirety of each of the above-mentioned patent applications is hereby incorporated by reference herein and made a part of this specification.

### BACKGROUND

In recent years, with the development of technologies such as data center, artificial intelligence, and supercomputers, more and more powerful ASICs are used to obtain applications, such as CPUs, GPUs, machine learning accelerators, network switches, servers, etc., which consume a large amount of current, such as thousands of amperes. In order to meet the rapid response to load dynamics, the current industry is to use a two-stage converter, that is, a front-stage converter (converting a 48V bus to a 12V bus or even a lower) + a post-stage voltage regulator (the voltage regulator usually uses interleaved multiphase buck and is connected in parallel, and then a reverse coupling inductor is added, so that the rapid response to load dynamic is easily achieved) to achieve a voltage conversion of 48V to 1V. However, due to the existence of the low-voltage bus (12V), a large conduction loss is generated, the efficiency of the whole machine is low, and the application is relatively complex.

In a second manner, a single-stage power converter is used to remove the 12V bus, and 48V is directly converted to 1V or lower, and the conversion efficiency of the power conversion assembly of the single-stage power converter is high and the power density is high. However, the output inductor of the single-stage power converter is often integrated in the transformer, so that the transformer cannot optimize the design, and a relatively low conduction loss and good dynamic performance cannot be obtained at the same time.

Therefore, how to develop a power conversion assembly and an electronic device to solve the problems faced by the prior art is an urgent problem in the art.

### SUMMARY

In view of the above, one of the objectives of the application is to provide a single-stage power conversion device, comprising an input positive terminal, an input negative terminal, an output positive terminal, an output negative terminal, at least one primary-side sub-circuit, at least one first synchronization unit, at least one second synchronization unit, at least two output inductors, and a closed loop; each primary-side sub-circuit comprises a primary-side winding; each synchronization unit comprises at least one secondary-side winding; one primary-side winding and the secondary-side winding of one first synchronization unit and the secondary-side winding of one second synchronization unit are coupled;

Each synchronization unit comprises a unit positive terminal, a unit negative terminal; and the unit negative terminal is electrically connected to the output negative terminal;

A first end of each of the output inductors is electrically connected to the unit positive terminal of one synchronization unit, and a second end of each of the output inductors is electrically connected to the output positive terminal;

The closed loop includes at least two auxiliary windings and a series inductor connected in series, each auxiliary winding is coupled with one of the at least two output inductors; the series inductor may be an external inductor, a parasitic inductance, or a combination of the external inductor and the parasitic inductance.

Preferably, a coupling coefficient between each auxiliary winding and one output inductor is greater than 0.5; a first end of each auxiliary winding and the first end of the output inductor coupled to each other are dotted terminals, and a second end of one auxiliary winding is sequentially connected to the first end of another auxiliary winding.

Preferably, each of the synchronization units further comprises at least one synchronous rectifier switch; a first end of each secondary-side winding is electrically connected to the unit positive terminal, and a second end of each secondary-side winding is electrically connected to a drain of one synchronous rectifier switch; and a source of each synchronous rectifier switch is electrically connected to the unit negative terminal.

Preferably, each primary-side sub-circuit further comprises one switch bridge arm and one capacitor bridge arm; the switch bridge arm comprises two primary-side switches, and the two primary-side switches are connected to a midpoint of the switch bridge arm; the capacitor bridge arm includes two primary-side capacitors connected to a midpoint of the capacitor bridge arm; the primary-side winding is connected between the midpoint of the switch bridge arm and the midpoint of the capacitor bridge arm, a first end of the primary-side winding is electrically connected to the midpoint of the switch bridge arm, and a second end of the primary-side winding is electrically connected to the midpoint of the capacitor bridge arm.

Preferably, each primary-side sub-circuit further comprises two switch bridge arms; each switch bridge arm comprises two primary-side switches, and the two primary-side switches of each switch bridge arm are connected to a midpoint of the one switch bridge arm; and the primary-side winding is connected between the midpoints of the two switch bridge arms.

Preferably, the single-stage power conversion device, comprising two primary-side sub-circuits, two first synchronization units, two second synchronization units, and four output inductors; each of the synchronization units comprises two secondary-side windings and two synchronous rectifier switches; the closed loop comprises four auxiliary windings and the series inductor connected in series, and each auxiliary winding is coupled to one of the four output inductors; and each primary-side sub-circuit comprises a primary-side upper switch and a primary-side lower switch.

Preferably, the single-stage power conversion device is controlled by using eight control signals; a first control signal is used for controlling the turn-on and turn-off of the primary-side upper switch of one primary-side sub-circuit; a second control signal is used for controlling the turn-on and turn-off of the primary-side upper switch of the other primary-side sub-circuit; a third control signal is used for controlling the turn-on and turn-off of the primary-side lower switch of one primary-side sub-circuit; a fourth control signal is used for controlling the turn-on and turn-off of the primary-side lower switch of the other primary-side sub-circuit; the duty cycles of the first control signal, the second control signal, the third control signal, and the fourth control signal are equal, and the four control signals are sequentially staggered by 90 degrees.

Preferably, a fifth control signal is complementary to the first control signal, and is used for controlling the turn-on and turn-off of one synchronous rectifier switch of one first synchronization unit and one synchronous rectifier switch of one second synchronization unit; a sixth control signal is complementary to the second control signal, and is used for controlling the turn-on and turn-off of one synchronous rectifier switch of the other first synchronization unit and one synchronous rectifier switch of the other second synchronization unit; a seventh control signal is complementary to the third control signal, and is used for controlling the turn-on and turn-off of the other synchronous rectifier switch of one first synchronization unit and the other synchronous rectifier switch of one second synchronization unit; a eighth control signal is complementary to the fourth control signal, and is used for controlling the turn-on and turn-off of the other synchronous rectifier switch of the other first synchronization unit and the other synchronous rectifier switch of the other second synchronization unit.

A single-stage power conversion device, comprising a circuit substrate, two transformer assemblies, and three inductor assemblies, wherein the circuit substrate comprises an upper surface and a lower surface opposite to each other;

Each of the transformer assemblies comprises a primary-side winding, at least two secondary-side winding combinations, and a transformer magnetic core, wherein each inductor assembly comprises an inductor winding and an inductor magnetic core; the primary-side winding and the secondary-side winding combination are arranged within the circuit substrate and/or on the upper surface and/or the lower surface; the transformer magnetic core is respectively assembled to the primary-side winding and the secondary-side winding combination from the upper surface and the lower surface; each of the inductor assemblies is provided on the lower surface;

The transformer assemblies and the inductor assemblies are sequentially arranged according to the order of the inductor assembly, the transformer assembly, the inductor assembly, the transformer assembly, and the inductor assembly.

Preferably, the single-stage power conversion device, further comprising a primary-side switch and a secondary-side synchronous rectifier switch, wherein the primary-side switch is arranged on the same side of the inductor assembly and the transformer assembly, and the secondary-side synchronous rectifier switch is arranged between the inductor assembly and the transformer assembly.

Preferably, the transformer magnetic core comprises two transformer side columns, at least one transformer winding column, a first side edge and a third side edge opposite to each other, and a second side edge and a fourth side edge opposite to each other; the second side edge is located on the left side of the third side edge, and the fourth side edge is located on the right side of the third side edge; the third side edges of the two transformer magnetic cores are adjacent to each other; the two transformer side columns and the at least one transformer winding column are arranged along the third side edge; and a winding channel is provided between the transformer side column and the transformer winding column and between the transformer winding columns.

Preferably, a first end and a second end of the primary-side winding of one transformer assembly are both disposed adjacent to the third side edge or the first side edge of the magnetic core of the transformer, and a first end and a second end of the primary-side winding of the other transformer assembly are disposed adjacent to the first side edge or the third side edge of the transformer magnetic core; the first end of the primary-side winding of each transformer assembly is disposed adjacent to one transformer side column, and the second end of the primary-side winding of each transformer assembly is disposed adjacent to the other transformer side column; each primary-side winding is wound N turns around the transformer winding column in a first direction from the first end to the second end.

Preferably, each secondary-side winding combination comprises a first secondary-side winding unit and a second secondary-side winding unit; each of the secondary-side winding units comprises two secondary-side windings; four secondary-side windings in each secondary-side winding combination are passed through one winding channel once, and the turns ratio of each primary-side winding to the four secondary-side windings in one secondary-side winding combination is 2 * N: 1: 1: 1: 1.

Preferably, the second ends of the two secondary-side windings in the same secondary-side winding unit are short-circuited together to form a second end of the secondary-side winding unit; and two secondary-side windings in the same secondary-side winding unit are passed through different winding channels in the same direction, and the first end and the second end of each secondary-side winding are arranged on two opposite sides of the transformer magnetic core; and the second end of the first secondary-side winding unit and the second end of the second secondary-side winding unit are arranged on two opposite sides of the transformer magnetic core.

Preferably, the single-stage power conversion device, further comprising a first output inductor, a second output inductor, a third output inductor, and a fourth output inductor; the three inductor assemblies are respectively a first inductor assembly, a second inductor assembly and a third inductor assembly; the first inductor assembly comprises a rectangular-frame-shaped inductor magnetic core, a window and a winding of the first output inductor; the third inductor assembly comprises a rectangular-frame-shaped inductor magnetic core, a window, and a winding of the fourth output inductor; the second inductor assembly comprises a dual-window-shaped inductor magnetic core, two windows, a winding of the second output inductor, and a winding of the third output inductor; the two windows are shared a horizontal column; the second inductor assembly is disposed between the first inductor assembly and the third inductor assembly.

Preferably, the winding of each output inductor is passed through a corresponding window from front to back to reach a second end of the winding of the output inductor; the first end of the winding is in front of the window.

Preferably, the single-stage power conversion device, further comprising four auxiliary assemblies and a series inductor; each of the auxiliary assemblies comprises an auxiliary winding and an auxiliary connector; the auxiliary winding and the winding of the output inductor are disposed in the window; each auxiliary winding is passed through a corresponding window from front to back to a second end of the auxiliary winding, and is coupled to the winding of the output inductor; the four auxiliary windings are sequentially connected in a manner that the second end of one auxiliary winding is electrically connected to the first end of another auxiliary winding, and is electrically connected to the series inductor to form a closed loop; and the series inductor may be an external inductor, a parasitic inductance, or a combination of the external inductor and the parasitic inductance.

Preferably, the transformer magnetic core of each of the transformer assemblies comprises two transformer winding columns; the two transformer winding columns are arranged between the two transformer side columns; a first end of each primary-side winding is arranged adjacent to one transformer side column and one transformer winding column, and a second end of each primary-side winding is arranged adjacent to the two transformer winding columns; and each primary-side winding is wound around the two transformer winding columns in an "8" shape from the first end to the second end.

Preferably, a specific winding manner of each primary-side winding from the first end to the second end is as follows: each primary-side winding is wound clockwise around one transformer winding column, and then wound counterclockwise around the other transformer winding column.

Preferably, the transformer magnetic core of each of the transformer assemblies comprises two transformer winding columns; the two transformer winding columns are arranged between the two transformer side columns; each of the transformer assemblies comprises four secondary-side winding combinations; each of the two secondary-side winding combinations satisfies mirror symmetry in the Y-axis direction; the four secondary-side winding combinations are respectively arranged around one transformer winding column; and second ends of the secondary-side winding units arranged on the same side of the transformer magnetic core are short-circuited.

Preferably, the secondary-side synchronous rectifier switch comprises a first secondary-side synchronous rectifier switch, a second secondary-side synchronous rectifier switch, a third secondary-side synchronous rectifier switch, and a fourth secondary-side synchronous rectifier switch; the first secondary-side synchronous rectifier switch and the third secondary-side synchronous rectifier switch satisfy mirror symmetry along the Y-axis direction; the second secondary-side synchronous rectifier switch and the fourth secondary-side synchronous rectifier switch satisfy mirror symmetry along the Y-axis direction; each secondary-side synchronous rectifier switch is disposed adjacent to and connected to the first end of the secondary-side winding.

Preferably, the upper surface of the circuit substrate comprises an input region; the input region is disposed adjacent to the second side edge of the transformer magnetic core; the primary-side switch is disposed in the input region; the primary-side switch comprises a first primary-side upper switch, a first primary-side lower switch, a second primary-side upper switch, and a second primary-side lower switch; the first primary-side upper switch and the first primary-side lower switch are disposed adjacent to one transformer assembly and disposed adjacent to the second side edge of the transformer magnetic core of the transformer assembly; the second primary-side upper switch and the second primary-side lower switch are disposed adjacent to the other transformer assembly and disposed adjacent to the second side edge of the transformer magnetic core of the other transformer assembly.

Preferably, both a first side and a third side of each transformer assembly are provided with an inductor winding metal column and a GND metal column; the inductor winding metal column is the inductor winding in the inductor assembly; and the GND metal column is a ground terminal of the single-stage power conversion device.

Preferably, the lower surface of the circuit substrate also comprises an input region, and the input region of the lower surface of the circuit substrate is arranged adjacent to the second side edge of each transformer magnetic core; the projection of the input region on the lower surface of the circuit substrate on the upper surface at least partially overlaps the projection of the input region on the upper surface of the circuit substrate.

Preferably, the input region on the lower surface of the circuit substrate comprises four primary-side capacitors; two primary-side capacitors of the four primary-side capacitors are disposed adjacent to one transformer assembly, and projections of the two primary-side capacitors on the upper surface at least partially overlap with the first primary-side upper switch and the first primary-side lower switch; the other two primary-side capacitors are disposed adjacent to the other transformer assembly, and projections of the other two primary-side capacitors on the upper surface at least partially overlap with the second primary-side upper switch and the second primary-side lower switch.

An inductor assembly, comprising an inductor magnetic core, an output inductor winding, and an auxiliary assembly; the inductor magnetic core includes a window and a frame surrounding the window, the frame includes a groove; the output inductor winding is in an "I" shape, and the output inductor winding is penetrated through the window; the auxiliary assembly is in an "n" shape, and the auxiliary assembly is spanned over the frame and is clamped in the groove; the auxiliary assembly includes an auxiliary winding and an auxiliary connector; and the auxiliary winding and the inductor winding are disposed in the window.

Preferably, the output inductor winding comprises a top end portion and a bottom end portion are used for soldering and fixing and electrical connection to an external element ; the auxiliary assembly comprises two bottom end portions and a top surface, the two bottom end portions are used for soldering and fixing and electrical connection to an external element; and there is a gap between the output inductor winding and the auxiliary winding.

Preferably, the bottom end portion of the output inductor winding is coplanar with the bottom end portion of the auxiliary assembly, and the top end portion of the output inductor winding is coplanar with the top surface of the auxiliary assembly.

Preferably, the top surface of the auxiliary assembly is provided with a top end portion, and the top end portion is used for soldering and fixing and electrical connection to the external element.

Preferably, a depth of the groove is greater than or equal to a thickness of the auxiliary assembly.

A single-stage power conversion device using a four-phase power circuit, comprising a circuit substrate and an adapter board; the circuit substrate and the adapter board both comprise an upper surface and a lower surface opposite to each other, and the lower surface of the circuit substrate is disposed adjacent to the upper surface of the adapter board; the upper surface of the circuit substrate has a first symmetry axis extending in an X-direction and a second symmetry axis extending in a Y-direction, and the circuit substrate is divided into a first region, a second region, a third region and a fourth region by the first symmetry axis and the second symmetry axis; the four regions are arranged clockwise according to the order of the first region, the second region, the fourth region and the third region; the first region is used for setting a first phase power circuit; the second region is used for setting a second phase power circuit; the third region is used for setting a third phase power circuit; the fourth region is used for setting a fourth phase power circuit;

The first phase power circuit and the second phase power circuit are arranged on one side of the first symmetry axis, and are symmetrically arranged along the second symmetry axis; the third phase power circuit and the fourth phase power circuit are arranged on the other side of the first symmetry axis, and are symmetrically arranged along the second symmetry axis; the first phase power circuit and the third phase power circuit are symmetrically arranged along the first symmetry axis, and the second phase power circuit and the fourth phase power circuit are symmetrically arranged along the first symmetry axis; the main circuit topology of the four-phase power circuit is the same.

Preferably, each of the four-phase power circuits comprises a primary-side sub-circuit and a secondary-side sub-circuit; the primary-side sub-circuit is a full-bridge circuit, and each secondary-side sub-circuit comprises two center-tap circuits electrically connected in parallel; each center-tap circuit comprises a synchronous rectifier switch, a secondary-side winding, and an output inductor.

Preferably, the primary-side sub-circuit comprises a primary-side winding, and the secondary-side sub-circuit comprises the secondary-side winding; the primary-side winding and the secondary-side winding of each of the four-phase power circuits are coupled in a same magnetic core to form a transformer; the circuit substrate includes a first transformer disposed in the first region, a second transformer disposed in the second region, a third transformer disposed in the third region, and a fourth transformer disposed in the fourth region.

Preferably, each transformer comprises a first side adjacent to the second symmetry axis, a third side opposite to the first side, a second side adjacent to the first symmetry axis, and a fourth side opposite to the second side; the four primary-side switches are disposed adjacent to the third side of the transformer, two primary-side switches of the four primary-side switches are disposed adjacent to the fourth side of the transformer, and the other two primary-side switches of the four primary-side switches are disposed adjacent to the second side of the transformer; and the synchronous rectifier switch in one center-tap circuit and the synchronous rectifier switch in the other central-tap circuit are respectively disposed on the second side and the fourth side of the transformer opposite to each other.

Preferably, the synchronous rectifier switches of the four-phase power circuit are arranged on the upper surface and the lower surface of the circuit substrate, and the output inductor is arranged on the lower surface of the circuit substrate; the projection of the synchronous rectifier switch arranged on the lower surface of the circuit substrate at least partially overlaps with the projection of the synchronous rectifier switch arranged on the upper surface of the circuit substrate on the upper surface, and is electrically connected in parallel by means of the circuit substrate; each output inductor comprises an inductor magnetic core and an inductor winding, and each inductor winding is passed through a central hole of the inductor magnetic core; and the synchronous rectifier switch is arranged in a gap between the inductor magnetic core and the circuit substrate.

Preferably, the synchronous rectifier switch in each center-tap circuit comprises two groups, and the inductor winding is arranged between the two groups of synchronous rectifier switches; an output terminal surface of each inductor winding is fixed and electrically connected to a pad provided on the upper surface of the adapter board, and an input end surface of each inductor winding is fixed and electrically connected to a pad provided on the lower surface of the circuit substrate.

Preferably, a synchronous rectifier switch of the four-phase power circuit is arranged on the lower surface of the circuit substrate, a grounding metal block is arranged between the synchronous rectifier switches arranged on the lower surface of the circuit substrate, and two ends of the grounding metal blocks are respectively fixed and electrically connected to the circuit substrate and the adapter board.

Compared with the prior art, the application has the following beneficial effects:

(1) The present application discloses a power conversion circuit with high power requirements. The primary-side circuit uses two groups of full-bridge circuits or half-bridge circuits in parallel architecture, and the secondary-side circuit uses N synchronous rectifier units and N inductors, N is a natural number of multiples of 4; by adding the auxiliary winding coupled to the inductor, the N auxiliary windings and the series inductor are connected in series to form a closed loop, so as to obtain higher conversion efficiency and power density, and improve the response capability to rapid transition of the load;

(2) On the other hand, the present application provides a power conversion device, which reduces the volume of the power conversion device by means of the component arrangement and a winding manner and structure design of a transformer assembly and an inductor assembly, thereby improving the load dynamic performance of the power conversion device.

### DESCRIPTION OF DRAWINGS

FIG. 1A is a schematic diagram of a principle of a power conversion circuit;

FIG. 1B is a schematic diagram of a principle of another power conversion circuit;

FIG. 2 is a control timing sequence of a power conversion circuit;

FIGS. 3A to 3B are schematic diagrams of winding of a primary-side winding and a secondary-side winding according to an embodiment;

FIGS. 4A and 4B are schematic diagrams of winding of a primary-side winding and a secondary-side winding according to another embodiment;

FIGS. 5A to 5B are schematic diagrams of a top surface/bottom surface of a power conversion device;

FIGS. 6A to 6D are three-dimensional schematic diagrams and an exploded schematic diagram of a power conversion device;

FIGS. 7A to 7C are three-dimensional schematic diagrams and an exploded schematic diagram of an inductor assembly.

FIG. 8 is a schematic diagram of a principle of another power conversion circuit;

FIGS. 9A to 9G are schematic structural diagrams of a power conversion device.

### DESCRIPTION OF THE EMBODIMENTS

One of the cores of the present application is to provide a single-stage power conversion device.

The present application provides a power conversion circuit satisfying a high-power requirement. The primary-side circuit uses two groups of half-bridge or full-bridge circuits in parallel architecture. The secondary-side circuit uses N synchronous rectifier units and N output inductors, where N is a natural number of multiple times of 4. By adding an auxiliary winding coupled to the output inductor, the N auxiliary windings and a series inductor are connected in series to form a closed loop, so as to obtain higher conversion efficiency and power density, and improve the response capability to rapid transition of the load. On the other hand, the present application provides a power conversion device, which can further reduce the volume of the power conversion device and improve the conversion efficiency of the power conversion device by designing a structure and a winding manner of a transformer and a winding manner and a structure of an inductor assembly, and further reducing the volume of the power conversion device by means of the component arrangement design of the power conversion device.

Technical solutions in the embodiments of the present disclosure will be clearly and completely described below with reference to the accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

### Embodiment 1

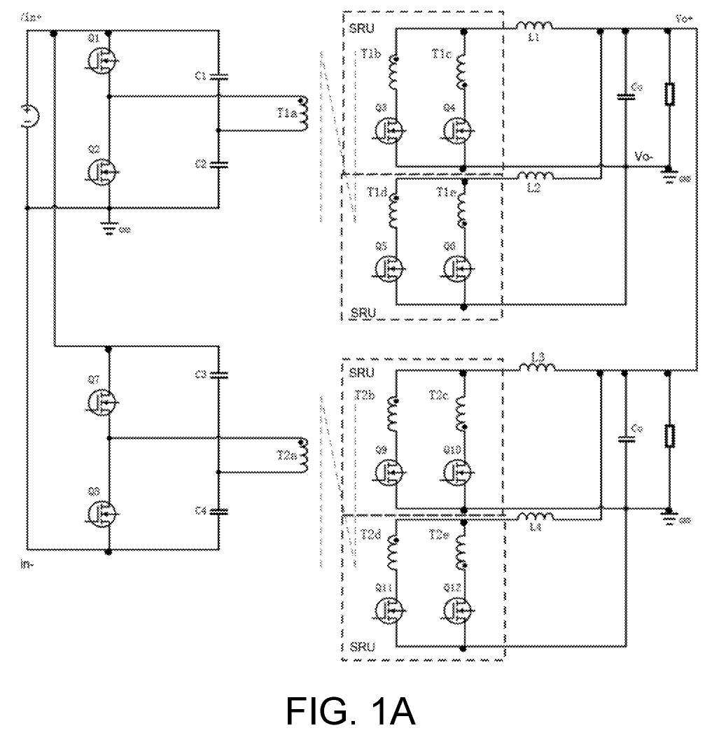

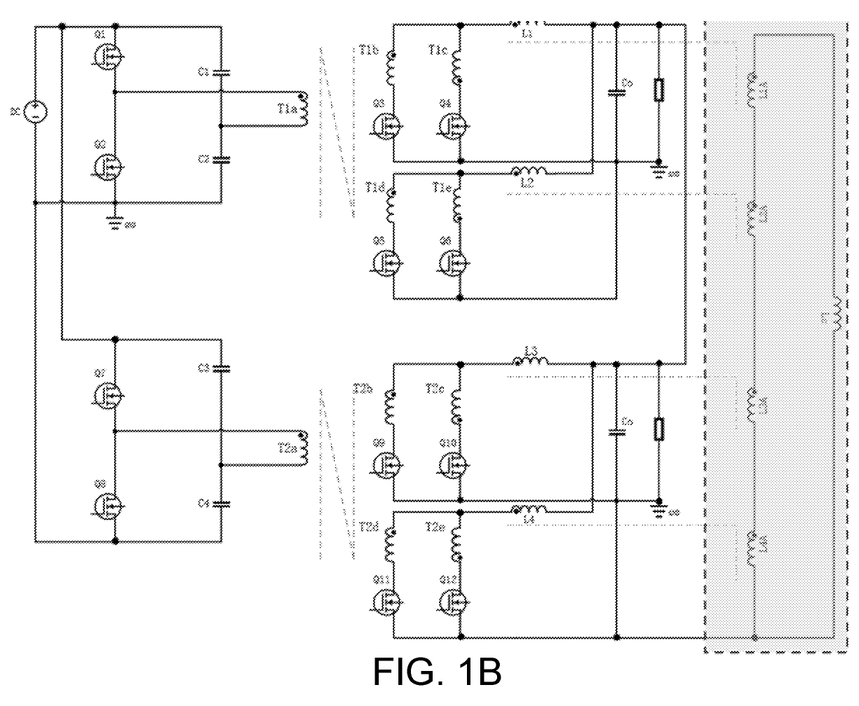

The present application provides a single-stage power conversion circuit, as shown in FIG. 1A. The power conversion circuit comprises an input positive terminal Vin+, an input negative terminal Vin-, an output positive terminal Vo+, an output negative terminal Vo-, a primary-side circuit, and a secondary-side circuit. In the present embodiment, the input negative terminal Vin- and the output negative terminal Vo- are short-circuited. The primary-side circuit uses two primary-side sub-circuits electrically connected in parallel, and the secondary-side uses a plurality of sets of center-tap synchronous rectifier circuits electrically connected in parallel. Each primary-side sub-circuit comprises one half-bridge circuit, which comprises two primary-side switches, two primary-side capacitors and one primary-side winding; each primary-side sub-circuit is connected between the input positive terminal and the input negative terminal; the two primary-side switches are connected in series to form a switch bridge arm, and the two primary-side capacitors are connected in series to form a capacitor bridge arm; and the primary-side winding is connected in series between a midpoint of the switch bridge arm and a midpoint of the capacitor bridge arm. The secondary-side circuit comprises four synchronous rectifier units (a synchronization unit for short) and four output inductors; each synchronization unit comprises two synchronous rectifier switches and two secondary-side windings, and each synchronization unit is electrically connected in series to one output inductor and then are connected in parallel between the output positive terminal and the output negative terminal. In another embodiment, the capacitor bridge arm may also be a switch bridge arm, that is, the primary-side sub-circuit comprises a full-bridge circuit, and the primary-side winding is connected between the midpoints of the two switch bridge arms. In addition, each primary-side sub-circuit may further comprise a DC-blocking capacitor, and the DC-blocking capacitor and the primary-side winding are connected in series and then connected between the midpoints of the two bridge arms.

Referring to FIG. 1A in detail, a first primary-side sub-circuit includes the switch bridge arm, the capacitor bridge arm, and the primary-side winding T1a. The switch bridge arm includes primary-side switches Q1 and Q2, and the primary-side switches Q1 and Q2 are connected to the midpoint of the switch bridge arm. The capacitor bridge arm includes primary-side capacitors C1 and C2, and the primary-side capacitors C1 and C2 are connected to the midpoint of the capacitor bridge arm. The primary-side winding T1a is connected between the midpoint of the switch bridge arm and the midpoint of the capacitor bridge arm; a first end of the primary-side winding T1a is electrically connected to the midpoint of the switch bridge arm, and a second end of the primary winding T1a is electrically connected to the midpoint of the capacitor bridge arm. A second primary-side sub-circuit comprises the switch bridge arm, the capacitor bridge arm, and the primary-side winding T2a. The switch bridge arm comprises primary-side switches Q7 and Q8, and the primary-side switches Q7 and Q8 are connected to the midpoint of the switch bridge arm. The capacitor bridge arm comprises primary-side capacitors C3 and C4, and the primary-side capacitors C3 and C4 are connected to the midpoint of the capacitor bridge arm. The connection mode of the second primary-side sub-circuit is the same as that of the first primary-side sub-circuit, the primary-side winding T2a is connected between the midpoint of the switch bridge arm and the midpoint of the capacitor bridge arm; a first end of the primary-side winding T2a is electrically connected to the midpoint of the switch bridge arm, and a second end of the primary-side winding T2a is electrically connected to the midpoint of the capacitor bridge arm.

A first secondary-side circuit comprises a first synchronization unit, a second synchronization unit, the output inductor L1, and the output inductor L2. The first synchronization unit comprising a unit positive terminal, a unit negative terminal, a synchronous rectifier switch combination (i.e. synchronous rectifier switches Q3 and Q4), and secondary-side windings T1b and T1c. Sources of the synchronous rectifier switches Q3 and Q4 are both electrically connected to the unit negative terminal and are electrically connected to the output negative terminal; a drain of the synchronous rectifier switch Q3 is electrically connected to a second end of the secondary-side winding T1b, a drain of the synchronous rectifier switch Q4 is electrically connected to a second end of the secondary-side winding T1c, and a first end of the secondary-side winding T1b and a first end of the T1c are both electrically connected to the unit positive terminal. The output inductor L1 is connected between the unit positive terminal and the output positive terminal Vo+; and a first end of the output inductor L1 is short-circuited to the unit positive terminal, and a second end of the output inductor L1 and the output positive terminal Vo+ are short-circuited. The second synchronization unit comprises a unit positive terminal, a unit negative terminal, a synchronous rectifier switch combination (i.e. synchronous rectifier switches Q5 and Q6), and the secondary-side windings T1d and T1e. Sources of the synchronous rectifier switches Q5 and Q6 are electrically connected to the unit negative terminal and are electrically connected to the output negative terminal; a drain of the synchronous rectifier switch Q5 is electrically connected to a second end of the secondary-side winding T1d, and a drain of the synchronous rectifier switch Q6 is electrically connected to a second end of the secondary-side winding T1e; and a first end of the secondary-side winding T1d and a first end of the T1e is electrically connected to the unit positive terminal. The output inductor L2 is connected between the unit positive terminal and the output positive terminal Vo+; and a first end of the output inductor L2 is short-circuited to the unit positive terminal, and a second end of the output inductor L2 and the output positive terminal Vo+ are short-circuited.

The primary-side winding T1a and the secondary-side windings T1b, T1c, T1d, and T1e are coupled together to form an ideal transformer. The first end of the primary-side winding T1a, the first ends of the secondary-side windings T1b & T1d, and the second ends of the secondary-side windings T1c & T1e are dotted terminals.

A second secondary-side circuit is the same as the first secondary-side circuit, and comprises a third synchronization unit, a fourth synchronization unit, the output inductor L3, and the output inductor L4. The third synchronization unit comprises a unit positive terminal, a unit negative terminal, a synchronous rectifier switch combination (i.e. synchronous rectifier switches Q9 and Q10), and secondary-side windings T2b and T2c; and sources of the synchronous rectifier switches Q9 and Q10 are electrically connected to the unit negative terminal and are electrically connected to the output negative terminal; a drain of the synchronous rectifier switch Q9 is electrically connected to a second end of the secondary-side winding T2b, a drain of the synchronous rectifier switch Q10 is electrically connected to a second end of the secondary-side winding T2c, and a first end of the secondary-side winding T2b and a first end of the secondary-side winding T2c are electrically connected to the unit positive terminal. The output inductor L3 is connected between the unit positive terminal and the output positive terminal Vo+; and a first end of the output inductor L3 is short-circuited to the unit positive terminal, and a second end of the output inductor L3 and the output positive terminal Vo+ are short-circuited. The fourth synchronization unit comprises a unit positive terminal, a unit negative terminal, a synchronous rectifier switch combination (i.e. synchronous rectifier switches Q11 and Q12), and secondary-side windings T2d and T2e, wherein sources of the synchronous rectifier switches Q11 and Q12 are electrically connected to the unit negative terminal; a drain of the synchronous rectifier switch Q11 is electrically connected to a second end of the secondary-side winding T2d, and a drain of the synchronous rectifier switch Q12 is electrically connected to a second end of the secondary-side winding T2e; and first ends of the secondary-side windings T2d and T2e are electrically connected to the unit positive terminal. The output inductor L4 is connected between the unit positive terminal and the output positive terminal Vo+; and a first end of the output inductor L4 is short-circuited to the unit positive terminal, and a second end of the output inductor L4 and the output positive terminal Vo+ are short-circuited.

The primary-side winding T2a and the secondary-side windings T2b, T2c, T2d, and T2e are coupled together to form the ideal transformer. The first end of the primary-side winding T2a, first ends of the secondary-side windings T2b & T2d, and second ends of the secondary-side windings T2c & T2e are dotted terminals.

In the power conversion circuit shown in the figure, the output inductors L1 & L2 & L3 & L4 may be coupled to each other or may not be coupled.

The power conversion circuit shown in FIG. 1B differs from that shown in FIG. 1A in that: FIG. 1B adds four auxiliary windings L1A & L2A & L3A & L4A, wherein the auxiliary winding L1A is coupled to the output inductor L1, the auxiliary winding L2A is coupled to the output inductor L2, the auxiliary winding L3A is coupled to the output inductor L3, and the auxiliary winding L4A is coupled to the output inductor L4. A first end of each auxiliary winding and the first end of the corresponding coupling output inductor have the same polarity, and are marked as point ends; specifically, the first end of L1A and the first end of L1 have the same polarity, and are marked as point ends; the first end of the L2A and the first end of the L2 have the same polarity, and are marked as point ends; the first end of the L3A and the first end of the L3 have the same polarity, and are marked as point ends; the first end of the L4A and the first end of the L4 have the same polarity, and are marked as point ends; and the four auxiliary windings are sequentially connected in series according to a manner in which the second end of one auxiliary winding is connected to the first end of another auxiliary winding, and then are connected to the series inductor Lc to form a closed loop. The series inductor Lc may be an external inductor, or may be a leakage inductance of the auxiliary winding or a parasitic inductance in the loop or a combination of the above two.

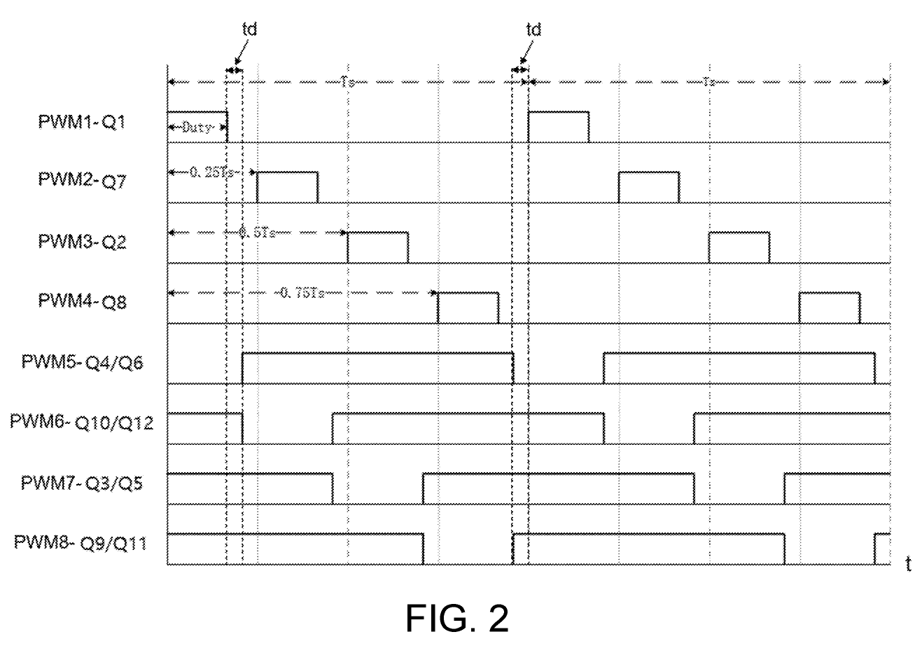

FIG. 2 is a control timing sequence corresponding to a power conversion circuit, and the power conversion circuit uses eight control signals, which are respectively a first control signal PWM1, a second control signal PWM2, a third control signal PWM3, a fourth control signal PWM4, a fifth control signal PWM5, a sixth control signal PWM6, a seventh control signal PWM7, and an eighth control signal PWM8, wherein the duty cycles of the first control signal PWM1, the second control signal PWM2, the third control signal PWM3, and the fourth control signal PWM4 (i.e. the duty cycle of the power conversion circuit) are equal, and the four control signals are sequentially staggered by 90 degrees; the first control signal PWM1 is used for controlling the turn-on and turn-off of the primary-side switch Q1, the second control signal PWM2 is used for controlling the turn-on and turn-off of the primary-side switch Q7, the third control signal PWM3 is used for controlling the turn-on and turn-off of the primary-side switch Q2, and the fourth control signal PWM4 is used for controlling the turn-on and turn-off of the primary-side switch Q8. Ignoring the dead time td between the control signals (as shown in the interval td shown in FIG. 2), the fifth control signal PWM5 is complementary to the first control signal PWM1 and used for controlling the turn-on and turn-off of the synchronous rectifier switches Q4 and Q6; the sixth control signal PWM6 is complementary to the second control signal PWM2, and is used for controlling the turn-on and turn-off of the synchronous rectifier switches Q10 and Q12; the seventh control signal PWM7 is complementary to the third control signal PWM3, and is used for controlling the turn-on and turn-off of the synchronous rectifier switches Q3 and Q5; and the eighth control signal PWM8 is complementary to the fourth control signal PWM4 and is used for controlling the turn-on and turn-off of the synchronous rectifier switches Q9 and Q11. In the present embodiment, the duty cycle is any value between 0 and 0.5, and the size of the duty cycle can be adjusted according to the output voltage by means of the control element.

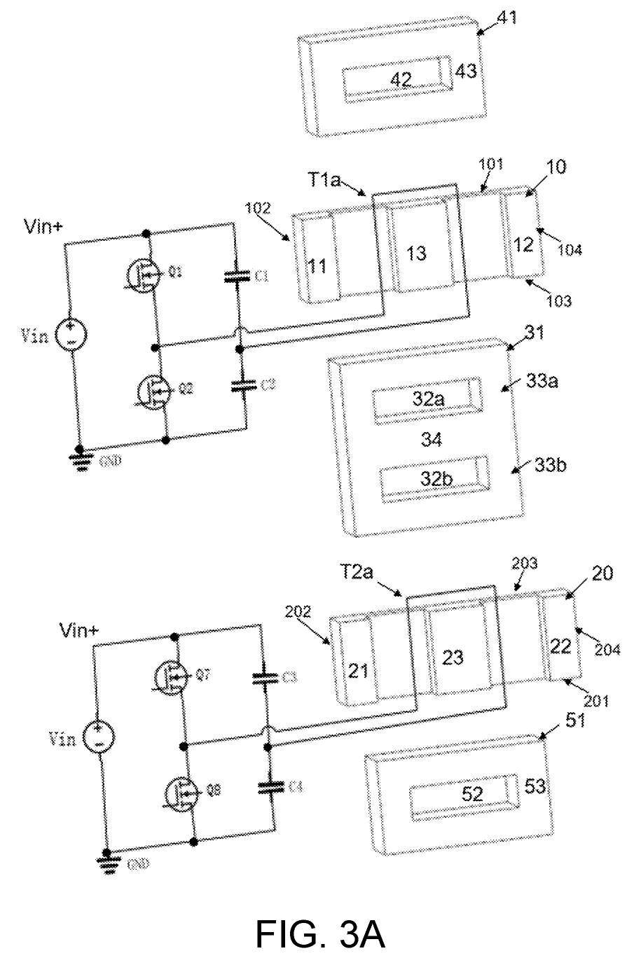

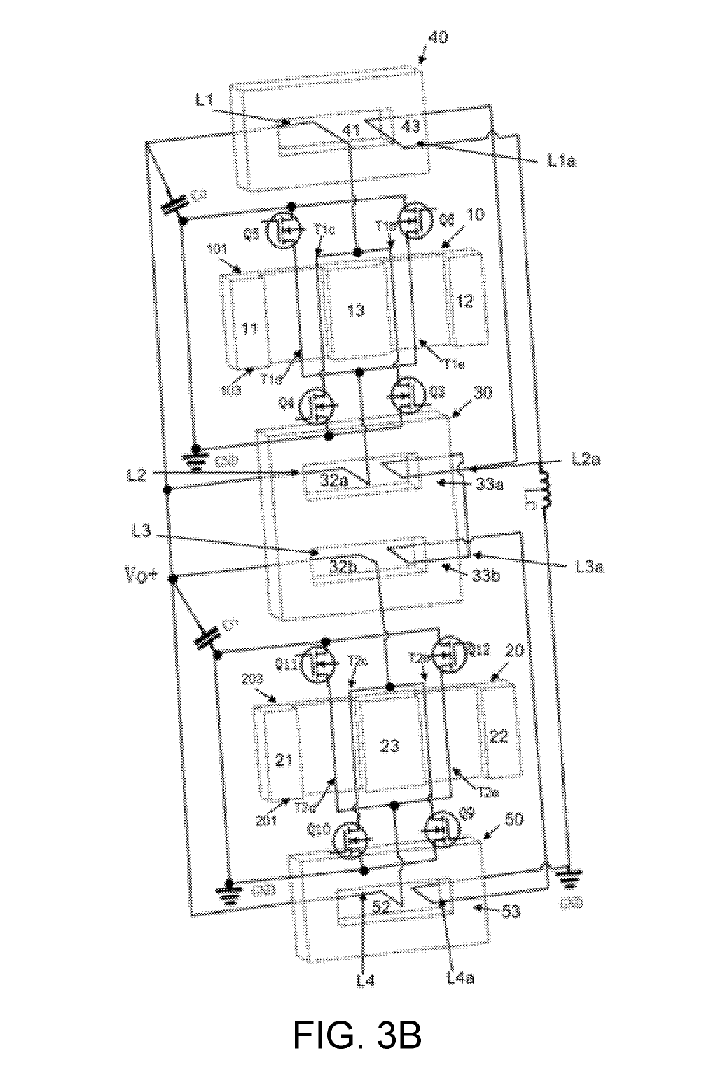

The power conversion device disclosed in the present application employs a circuit topology as shown in FIG. 1A and 1B and a control timing sequence as shown in FIG. 2. In the present embodiment, the power conversion device comprises a first transformer assembly 10, a second transformer assembly 20, a first inductor assembly 30, a second inductor assembly 40 and a third inductor assembly 50, as shown in FIGS. 3A and 3B . FIG. 3A is a winding manner of a primary-side winding and a connection manner with a primary-side switch; and FIG. 3B is a winding manner of a secondary-side winding and a connection manner with a synchronous rectifier switch, a winding manner of an inductor winding, and a connection manner. The first inductor assembly 30 is arranged between the two transformer assemblies 10 and 20, the first transformer assembly 10 is arranged between the second inductor assembly 40 and the first inductor assembly 30, and the second transformer assembly 20 is arranged between the first inductor assembly 30 and the third inductor assembly 50; the primary-side switch is arranged on the same side of the two transformer assemblies, such as the left side.

The first transformer assembly 10 includes a first transformer magnetic core, the primary-side winding T1a, and the secondary-side windings T1b & T1c & T1d & T1e. The first transformer magnetic core includes transformer side columns 11 and 12 and a transformer winding column 13. The first transformer magnetic core is an E-shaped magnetic core, and further comprises a first side edge 101 and a third side edge 103 opposite to each other, a second side edge 102 and a fourth side edge 104 opposite to each other, and the second side edge 102 is located on the left side of the third side edge 103, and the fourth side edge 104 is located on the right side of the third side edge 103. With reference to FIG. 3A, the first end and the second end of the primary-side winding T1a are both arranged adjacent to the third side edge 103 of the first transformer magnetic core, the first end is arranged adjacent to the transformer side column 11, and the second end is arranged adjacent to the transformer side column 12; the primary-side winding T1a is wound N turns around the transformer winding column 13 along a first direction from the first end to the second end. In this embodiment, the first direction is a clockwise direction, and the primary-side winding T1a wound one turn is taken as an example for description. With reference to FIG. 3B, the first ends of the secondary-side winding T1b and the secondary-side winding T1c are both disposed adjacent to the first side edge 101 of the first transformer magnetic core, and the second ends of the secondary-side winding T1b and the secondary-side winding T1c are both disposed adjacent to the third side edge 103 of the first transformer magnetic core. The secondary-side winding T1b is sequentially passed through the first side edge 101, a channel between the transformer side column 12 and the transformer winding column 13 and the third side edge 103 (i.e. in the third direction) from the first end to the second end; the secondary-side winding T1c is sequentially passed through the first side edge 101, a channel between the transformer side column 11 and the transformer winding column 13, and the third side edge 103 (i.e. in the third direction) from the first end to the second end. The first ends of the secondary-side winding T1d and the secondary-side winding T1e are disposed adjacent to the third side edge 103 of the first transformer magnetic core, and the second ends of the secondary-side winding T1d and the secondary-side winding T1e are both disposed adjacent to the first side edge 101 of the first transformer magnetic core. The secondary-side winding T1d is sequentially passed through the third side edge 103, the channel between the transformer side column 11 and the transformer winding column 13, and the first side edge 101 (i.e. in a fourth direction) from the first end to the second end; the secondary-side winding T1e is sequentially passed through the third side edge 103, the channel between the transformer side column 12 and the transformer winding column 13, and the first side edge 101 (i.e. in the fourth direction) from the first end to the second end. In the present embodiment, the secondary-side windings T1b & T1c & T1d & T1e are respectively wound half turn around the transformer winding column 13. Therefore, in the first transformer assembly, the turns ratio of the primary-side winding to the secondary-side windings is 2 * N: 1: 1: 1: 1. Compared with a conventional transformer, under the condition that the same turns ratio is obtained, turns of the primary-side winding and the secondary-side winding in the present embodiment is halved, thereby effectively reducing the copper loss generated on the transformer winding, and further improving the conversion efficiency of the power conversion device. Here, the third direction is opposite to the fourth direction.

Similarly, the second transformer assembly 20 comprises a second transformer magnetic core, the primary-side winding T2a, and the secondary-side windings T2b & T2c & T2d & T2e. The second transformer magnetic core is an E-shaped magnetic core, including transformer side columns 21 and 22 and a transformer winding column 23. The second transformer magnetic core further comprises a first side edge 201 and a third side edge 203 which are opposite to each other, a second side edge 202 and a fourth side edge 204 opposite to each other, and the second side edge 202 is located on the left side of the third side edge 203, and the fourth side edge 204 is located on the right side of the third side edge 203. The third side edge 203 of the second transformer magnetic core is located opposite to and adjacent to the third side edge 103 of the first transformer magnetic core; the first side edge 101 of the first transformer magnetic core, the third side edge 103 of the first transformer magnetic core, the third side edge 203 of the second transformer magnetic core, and the first side edge 201 of the first transformer magnetic core are sequentially from top to bottom. With reference to FIG. 3A, both the first end and the second end of the primary-side winding T2a are disposed adjacent to the first side edge 201 of the second transformer magnetic core, and the first end is disposed adjacent to the transformer side column 21, and the second end is disposed adjacent to the transformer side column 22; the primary-side winding T2a is wound N turns around the transformer winding column 23 from the first end to the second end along the first direction; in the present embodiment, the winding wound one turn is taken as an example for description. With reference to FIG. 3B, the first ends of the secondary-side winding T2b and the secondary-side winding T2c are both disposed adjacent to the third side edge 203 of the second transformer magnetic core, and the second ends of the secondary-side winding T2b and the secondary- side winding T2c are both disposed adjacent to the first side edge 201 of the second transformer magnetic core. The secondary-side winding T2b is sequentially passed through the third side edge 203, a channel between the transformer side column 22 and the transformer winding column 23, and the first side edge 201 (i.e. in the third direction) from the first end to the second end; the secondary side winding T2c is sequentially passed through the third side edge 203, a channel between the transformer side column 21 and the transformer winding column 23, and the first side edge 201 (i.e. in the third direction) from the first end to the second end. The first ends of the secondary-side winding T2d and the secondary-side winding T2e are both disposed adjacent to the first side edge 201 of the second transformer magnetic core, and the second ends of the secondary-side winding T2d and the secondary-side winding T2e are both disposed adjacent to the third side edge 203 of the second transformer magnetic core. The secondary-side winding T2d is sequentially passed through the first side edge 201, the channel between the transformer side column 21 and the transformer winding column 23, and the third side edge 203 (i.e. in the fourth direction) from the first end to the second end; the secondary-side winding T2e is sequentially passed through the first side edge 201, the channel between the transformer side column 22 and the transformer winding column 23, and the third side edge 203 (i.e. in the fourth direction) from the first end to the second end. In the present embodiment, the secondary-side windings T2b & T2c & T2d &T2e are respectively wound half turn around the transformer winding column 23, therefore, in the second transformer assembly, the turns ratio of the primary-side winding to the secondary-side windings is 2 * N: 1: 1: 1: 1. Compared with the conventional transformer, under the condition that the same turns ratio is obtained, turns of the primary-side winding and the secondary-side windings in the present embodiment is halved, thereby effectively reducing the copper loss generated on the transformer winding, and further improving the conversion efficiency of the power conversion device.

In the present embodiment, the unit positive terminal of each synchronization unit is electrically connected to the output positive terminal Vo+ by means of the output inductor, the first end of each output inductor is electrically connected to the unit positive terminal of a corresponding synchronization unit, the second end of each output inductor is electrically connected to the output positive terminal Vo+, and the unit negative terminal of each synchronization unit is directly electrically connected to the output negative terminal Vo-.

As shown in FIG. 3B, the power conversion device further comprises the inductor assemblies 30 & 40 & 50, the inductor assembly 40 comprises a rectangular-frame-shaped inductor magnetic core 41, a window 42, and a winding of the output inductor L1. The inductor assembly 50 comprises a rectangular-frame-shaped inductor magnetic core 51, a window 52, and a winding of the output inductor L4; the inductor assembly 30 comprises a dual-window-shaped inductor magnetic core 31, windows 32a and 32b, and windings of the output inductors L2 and L3; the inductor assembly 30 may be regarded as two rectangular-frame-shaped inductor magnetic cores adjacent to each other, and the shared horizontal column 34 forms a structure with two windows arranged vertically. Each of the output inductors L1 & L2 & L3 & L4 is passed through a corresponding window, for example, the winding of the output inductor L1 is passed through the window 42 from front to back to reach the second end of the winding of L1, the first end of the winding of L1 is in front of the window; the winding of the output inductor L2 is passed through the window 32a from front to back to reach the second end of the winding of L2, the first end of the winding L2 is in front of the window; the winding of the output inductor L3 is passed through the window 32b from front to back to reach the second end of the winding of L3, the first end of the winding of L3 is in front of the window; and the winding of the output inductor L4 is passed through the window 52 from front to back to reach the second end of the winding of L4, the first end of the winding of L4 is in front of the window. Each output inductor is wound one turn.

In addition, the power conversion device can also use a Trans-Inductor Voltage Regulator (TLVR) to combine the output inductor and the TLVR together, and meanwhile, the response capability of fast transition of the load is taken into consideration while obtaining higher efficiency and power conversion. In detail, as shown in FIG. 3B, four auxiliary windings L1a & L2a & L3a & L4a are included, and the auxiliary winding L1a is passed through the window 42 from front to back to reach the second end of L1a, wound around a frame 43, and is coupled to the winding of the output inductor L1; the auxiliary winding L2a is passed through the window 32a from front to back to reach the second end of L2a, wound around a frame 33a, and is coupled to the winding of the output inductor L2; the auxiliary winding L3a is passed through the window 32b from front to back to reach the second end of L3a, wound around a frame 33b, and is coupled to the winding of the output inductor L3; and the auxiliary winding L4a is passed through the window 52 from front to back to reach the second end of L4a, wound around a frame 53, and is coupled to the winding of the output inductor L4. A coupling coefficient of each auxiliary winding and the corresponding output inductor winding is greater than 0.5, and the four auxiliary windings are sequentially connected by using a non-point end of one auxiliary winding and a point end of another auxiliary winding, and are electrically connected to the series inductor Lc to form the closed loop; that is, the four auxiliary windings are sequentially connected by using the second end of one auxiliary winding and the first end of another auxiliary winding, and are electrically connected to the series inductor Lc to form the closed loop.

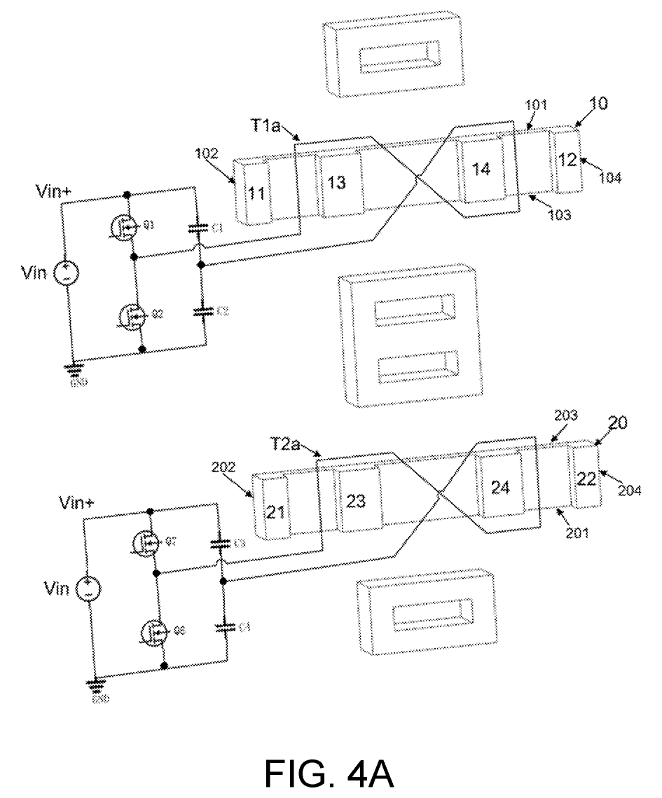

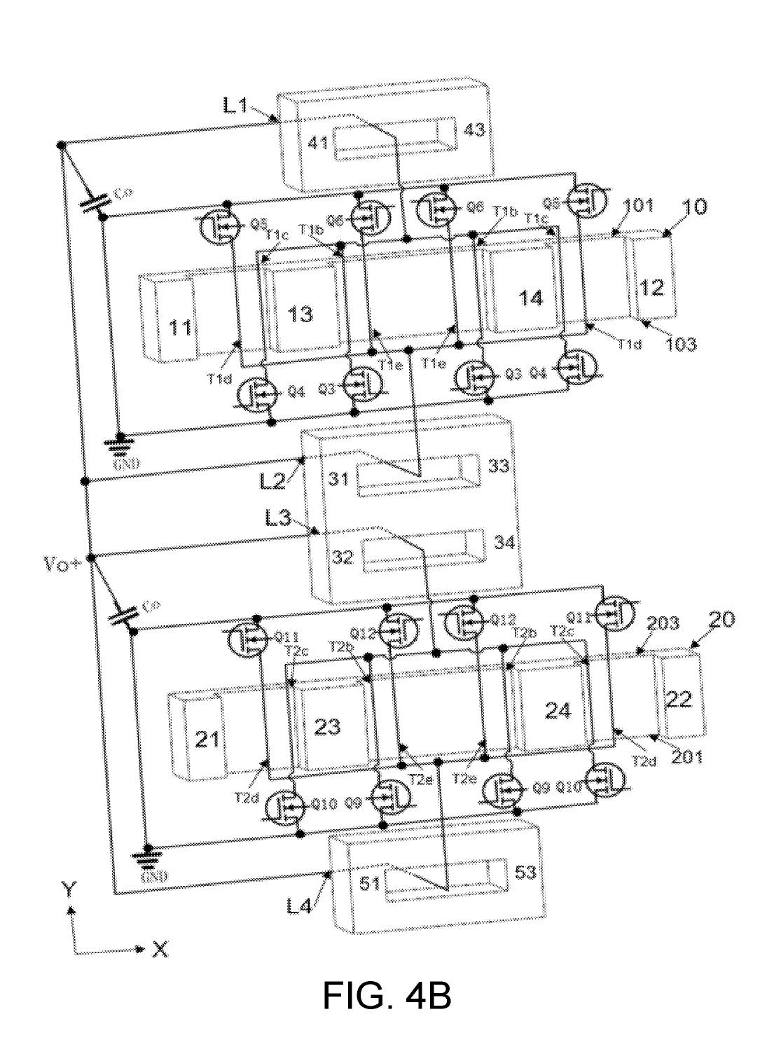

Furthermore, in order to meet the requirements of load on large currents, the power conversion device needs to further increase the output power. In another embodiment, the demand for large output power is met by adding a third secondary-side circuit and a fourth secondary-side circuit, as shown in FIGS. 4A and 4B. Correspondingly, one transformer winding column is added to each transformer magnetic core. In the transformer assembly 10, a newly transformer winding column 14 is added; the transformer winding column 14 is arranged between the transformer winding column 13 and the transformer side column 12; in the transformer assembly 20, a newly transformer winding column 24 is added; and the transformer winding column 24 is arranged between the transformer winding column 23 and the transformer side column 22. The first end of the primary-side winding T1a is disposed adjacent to the transformer side column 11 and the transformer winding column 13, and the second end of the primary-side winding T1a is disposed adjacent to the transformer winding columns t13 and 14. The primary-side winding T1a is wound N turns around the transformer winding columns 13 and 14 in a "8"-shape from the first end to the second end. In detail, the primary-side winding T1a may be wound one turn around the transformer winding column 13 in a clockwise direction and then wound one turn around the transformer winding column 14 in a counterclockwise direction; specifically, the first end of T1a starts from the third side edge 103 of the first transformer magnetic core, which is passed through the channel between the transformer side column 11 and the transformer winding column 13, passed through the first side edge 101, then passed through the channel between the transformer winding column 13 and the transformer winding column 14, and then passed through the third side edge 103, passed through the channel between the transformer winding column 14 and the transformer side column 12, passed through the first side edge, and then passed through the channel between the transformer winding column 13 and the transformer winding column 14 to reach the second end of T1a, thereby completing one turn winding of T1a; according to the winding path, the winding is continued, and the N turns winding of T1a can also be completed. In another embodiment, the primary-side winding T1a may also be wound N turns around the transformer winding column 13 in a clockwise direction, and then wound N turns around the transformer winding column 14 in a counterclockwise direction. The first end of the primary-side winding T2a is disposed adjacent to the transformer side column 21 and the transformer winding column 23, and the second end of the primary-side winding T2a is disposed adjacent to the transformer winding columns 23 and 24. The winding manner of the primary-side winding T2a is similar to the winding manner of the primary-side winding T1a, the primary-side winding T2a is wound N turns around the transformer winding columns 23 and 24 in a "8"-shape from the first end to the second end. In detail, the primary-side winding T2a may be wound one turn around the transformer winding column 23 in a clockwise direction and then wound one turn around the transformer winding column 24 in a counterclockwise direction; specifically, a first end of T2a starts from a first side edge 201 of the second transformer magnetic core, which is passed through the channel between the transformer side column 21 and the transformer winding column 23, and then passed through a third side edge 203, then passed through the channel between the transformer winding column 23 and the transformer winding column 24, and then passed through the first side edge 201, then passed through the channel between the transformer winding column 24 and the transformer side column 22, and then passed through the third side edge 203, and then passed through the channel between the transformer winding column 23 and the transformer winding column 24 to reach the second end of T2a, thereby completing one turn winding of T2a. According to the winding path, the winding is continued, and the N turns winding of T2a can also be completed. In another embodiment, the primary-side winding T2a may also be wound N turns around the transformer winding column 23 in a clockwise direction, and then wound N turns around the transformer winding column 24 in a counterclockwise direction.

Referring to FIG. 4B, the winding manner of the secondary windings T1b & T1c & T1d & T1e in the first secondary-side circuit is the same as that in Embodiment 1, all of which are wound half turn around the transformer winding column 13. The third secondary-side circuit also includes the secondary-side windings T1b & T1c & T1d & T1e, synchronous rectifier switches Q3 & Q4 & Q5 & Q6, the secondary-side windings T1b & T1c & T1d & T1e are wound half turn around the transformer winding column 14, and the third secondary-side circuit and the first secondary-side circuit satisfy the mirror symmetry along the Y-axis direction.

The secondary-side windings T1b & T1c & T1d & T1e in the third secondary-side circuit are wound half turn around the winding column 14 in the same winding manner and are coupled with the primary-side winding wound on the winding column 14. The first ends of the secondary-side windings T1b and T1c in the third secondary-side circuit are both disposed adjacent to the first side edge 101, and are short-circuited to the first ends of the secondary-side windings T1b and T1c in the first secondary-side circuit, and are then electrically connected to the windings of the output inductor L1; the second end of the secondary-side winding T1b is electrically connected to the drain of the synchronous rectifier switch Q3; and the second end of the secondary-side winding T1c is electrically connected to the drain of the synchronous rectifier switch Q4. The sources of the synchronous rectifier switches Q3 and Q4 in the first secondary-side circuit and the third secondary-side circuit are short-circuited and electrically connected to the output negative terminal Vo- (i.e. GND). The secondary-side winding T1b in the third secondary-side circuit is sequentially passed through the first side edge 101, the channel between the transformer winding columns 13 and 14, and the third side edge 103 from the first end to the second end; the secondary-side winding T1c is sequentially passed through the first side edge 101, the channel between the transformer winding column 14 and the transformer side column 12 and the third side edge 103 from the first end to the second end. The first ends of the secondary-side windings T1d and T1e in the third secondary-side circuit are both disposed adjacent to the third side edge 103, and are short-circuited to the first ends of the secondary-side windings T1d and T1e in the first secondary-side circuit, and then electrically connected to the winding of the output inductor L2; the second end of the secondary-side winding T1d is electrically connected to the drain of the synchronous rectifier switch Q5, and the second end of the secondary-side winding T1e is electrically connected to the drain of the synchronous rectifier switch Q6; and sources of the synchronous rectifier switches Q5 and Q6 in the first secondary-side circuit and the third secondary-side circuit is short-circuited and electrically connected to the output negative terminal Vo- (i.e. GND). The secondary-side winding T1d in the third secondary-side circuit is sequentially passed through the third side edge 103, the channel between the transformer side column 12 and the transformer winding column 14, and the first side edge 101 from the first end to the second end; the secondary-side winding T1e in the third secondary-side circuit is sequentially passed through the third side edge 103 , the channel between the transformer winding columns 13 and 14 and the first side edge 101 from the first end to the second end. In the present embodiment, the synchronous rectifier switches with the same label can use the same control signal, so that the first secondary-side circuit and the third secondary-side circuit are connected in parallel, or the second secondary-side circuit and the fourth secondary-side circuit are connected in parallel.

Similarly, in the fourth secondary-side circuit, the secondary-side windings T2b & T2c & T2d & T2e and the synchronous rectifier switches Q9 & Q10 & Q11 & Q12 are also included, the secondary-side windings T2b & T2c & T2d & T2e are wound half-turn around the transformer winding column 24, and similarly, the fourth secondary-side circuit and the first secondary-side circuit satisfy the mirror symmetry along the Y-axis direction. The connection manner and arrangement thereof may refer to the connection manner and arrangement of the first, second and third secondary-side circuits, and details are not described herein again. In this embodiment, an auxiliary closed loop (including auxiliary windings L1a & L2a & L3a & L4a and series inductor Lc) may also be added, the connection manner is the same as that in FIG. 3B, and the same technical effect may also be obtained.

Theoretically, if the output power of the power conversion device is doubled, the number of power devices in the power conversion device needs to be doubled. However, in the present application, only the secondary-side circuit needs to be doubled, and in the case that the half-bridge structure is maintained, the primary-side switch with a smaller on-resistance can be used, or the same primary-side switch can be used in parallel, or the half-bridge circuit can also be changed to the full-bridge circuit, which can meet the requirement of doubling the output power. The transformer is changed from one transformer winding column to two transformer winding columns, so that the primary-side winding in the first primary-side sub-circuit and the four secondary-side windings in the first secondary-side circuit and the four secondary-side windings in the third secondary-side circuit can be integrated in the same transformer assembly. Similarly, the primary-side winding in the second primary-side sub-circuit and four secondary-side windings in the second secondary-side circuit and four secondary-side windings in the fourth secondary-side circuit are integrated in the same transformer assembly. When the output power of the power conversion device is doubled, the volume of the inductor is doubled, and the power can also be increased by increasing the number of parallel inductors, or the same effect can be obtained by changing the shape, material or air gap of the inductor core. Furthermore, with the above series of improvement principles, the output power of the power conversion device can be further improved.

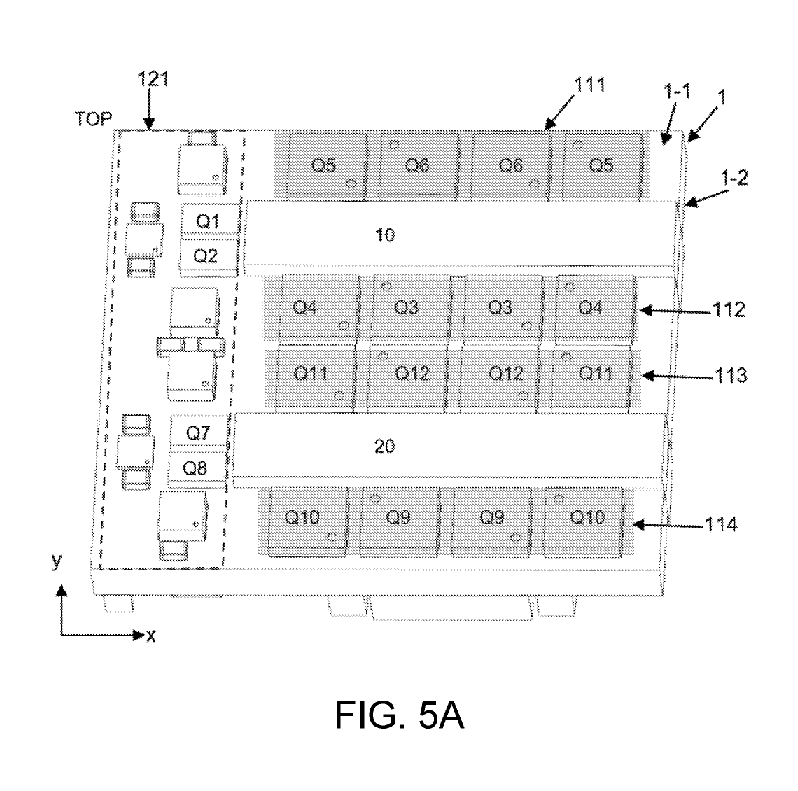

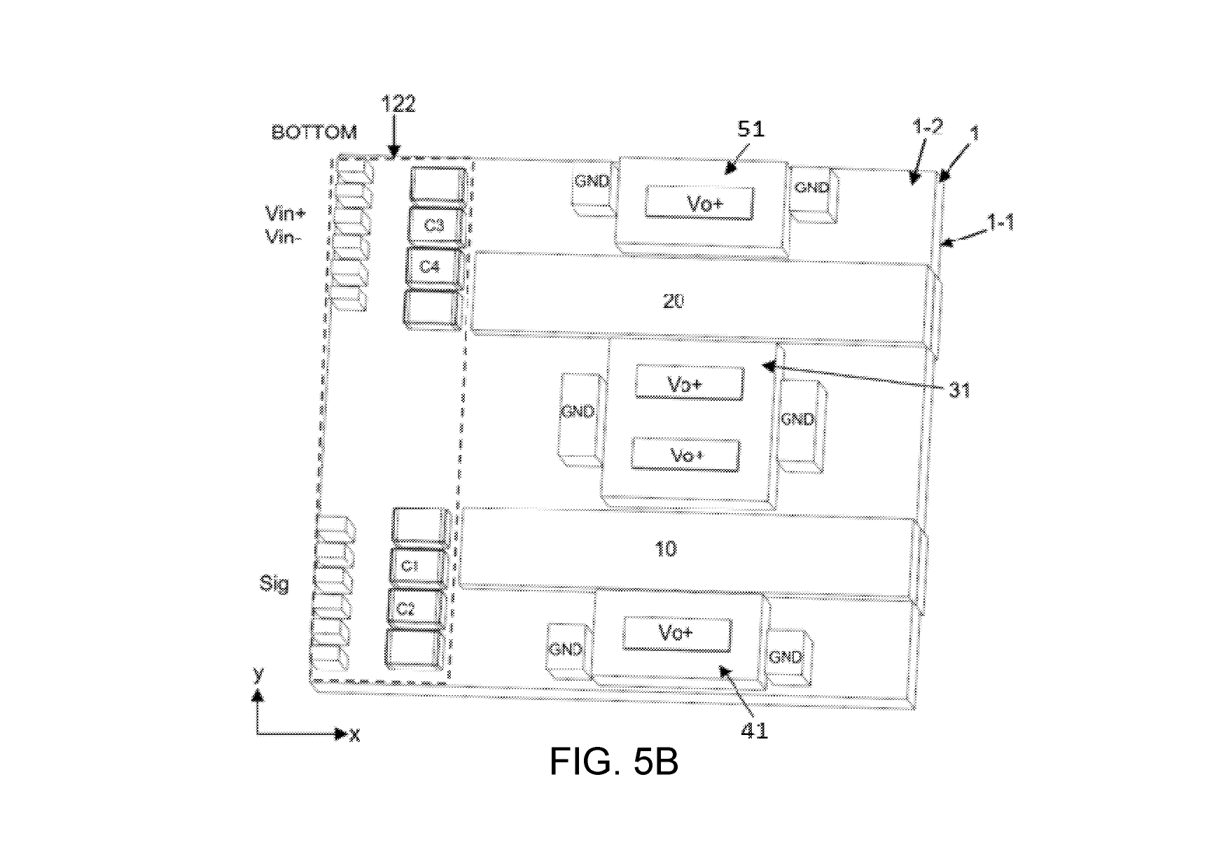

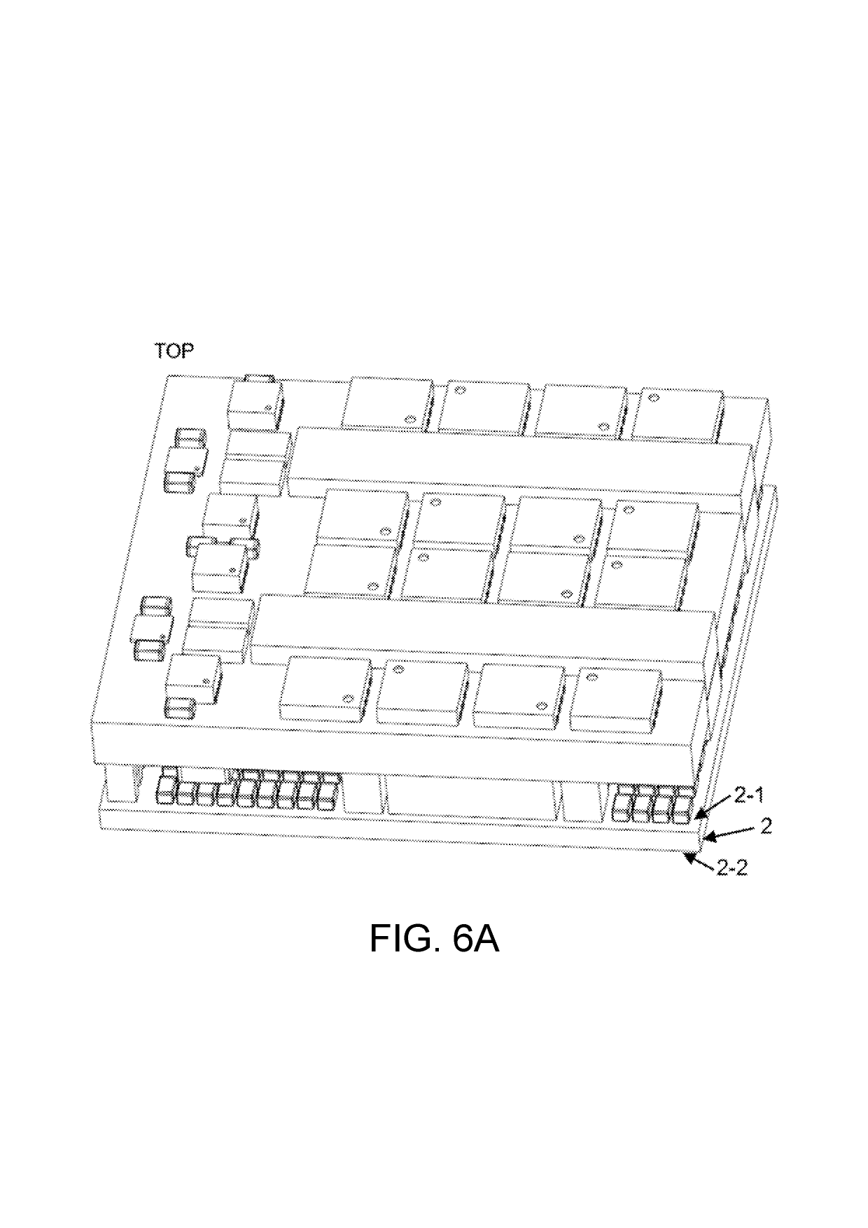

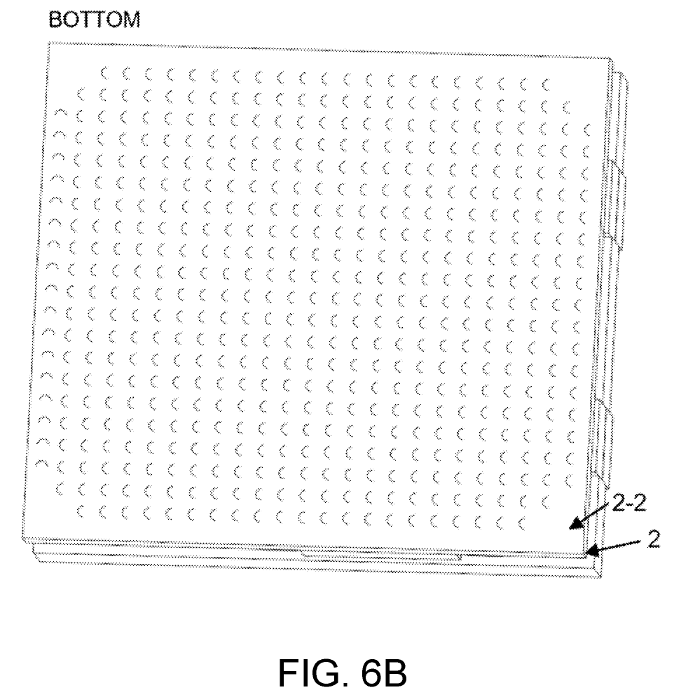

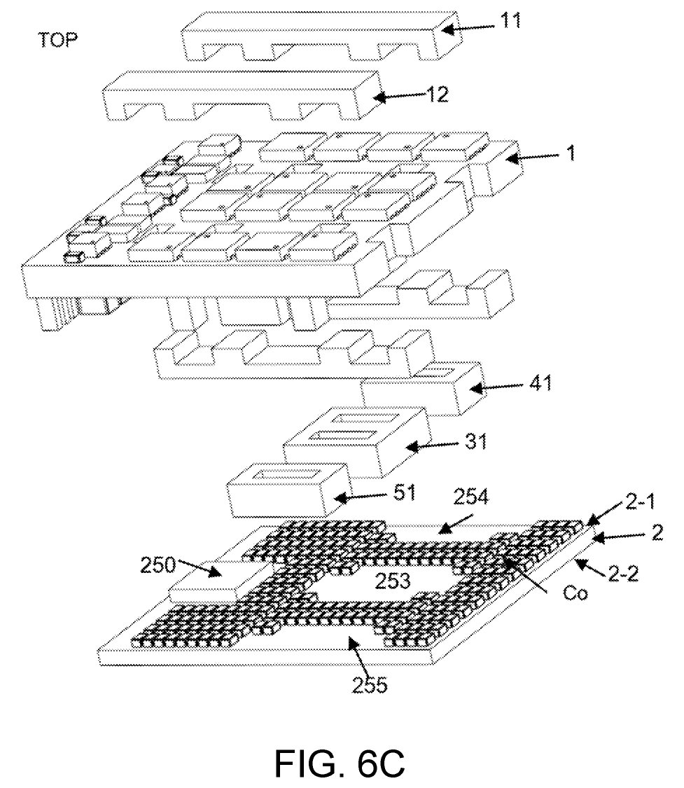

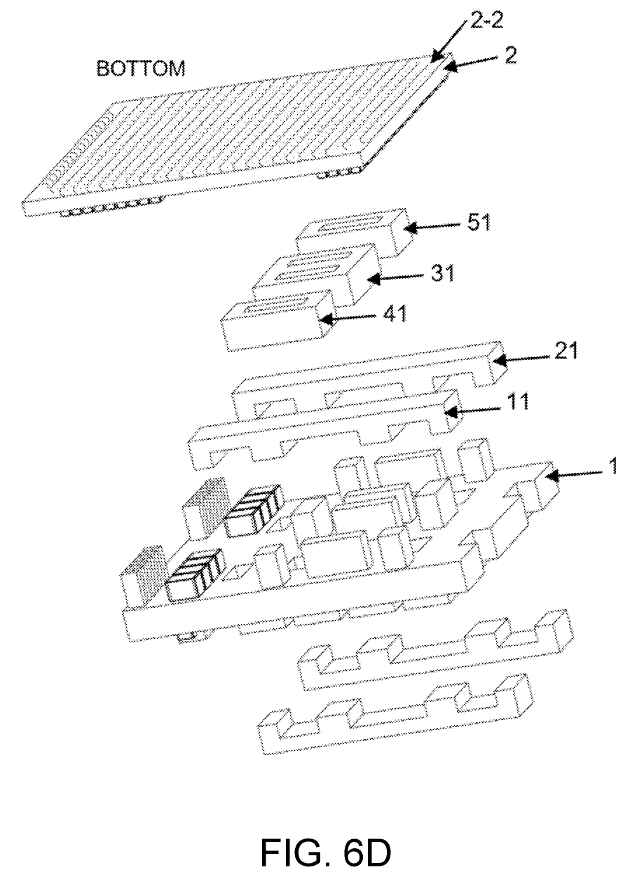

The arrangement of the power conversion device shown in this embodiment is shown in FIGS. 5A and 5B , FIG. 5A is a schematic diagram of a top surface arrangement of a power conversion device, and FIG. 5B is a schematic diagram of a bottom surface arrangement of a power conversion device. The power conversion device comprises a circuit substrate 1, the circuit substrate 1 comprises an upper surface 1-1 and a lower surface 1-2 which are opposite to each other. As shown in FIG. 5A, and referring to FIGS. 6C and 6D simultaneously, in the top surface of the power conversion device, sequentially from top to bottom, the synchronous rectifier switch combination of the second synchronization unit (comprising synchronous rectifier switches Q5 and Q6), the transformer assembly 10, the synchronous rectifier switch combination of the first synchronization unit (comprising synchronous rectifier switches Q3 & Q4), and the synchronous rectifier switch combination of the fourth synchronization unit (comprising synchronous rectifier switches Q11 and Q12), the transformer assembly 20 and the synchronous rectifier switch combination of the third synchronization unit (comprising synchronous rectifier switches Q9 & Q10). The synchronous rectifier switch of the second synchronization unit of the first secondary-side circuit and the synchronous rectifier switch of the second synchronization unit of the third secondary-side circuit satisfy the mirror symmetry in the Y-axis direction, specifically from left to right: the synchronous rectifier switch Q5 of the first secondary-side circuit, the synchronous rectifier switch Q6 of the first secondary-side circuit, the synchronous rectifier switch Q6 of the third secondary-side circuit, and the synchronous rectifier switch Q5 of the third secondary-side circuit; similarly, the synchronous rectifier switch of the first synchronization unit of the first secondary-side circuit and the synchronous rectifier switch of the first synchronization unit of the third secondary-side circuit satisfy the mirror symmetry in the Y-axis direction; similarly, the synchronous rectifier switch of the second synchronization unit of the second secondary-side circuit and the synchronous rectifier switch of the second synchronization unit of the fourth secondary-side circuit satisfy the mirror symmetry in the Y-axis direction; and similarly, the synchronous rectifier switch of the first synchronization unit of the second secondary-side circuit and the synchronous rectifier switch of the first synchronization unit of the fourth secondary-side circuit satisfy the mirror symmetry in the Y-axis direction. The upper surface 1-1 further comprises an input region 121; the primary-side switch, an input capacitor, a controller or other element is provided on the input region 121; the input region 121 is disposed adjacent to the second side edge 102 of the first transformer magnetic core or the second side edge 202 of the second transformer magnetic core. Primary-side switches Q1 and Q2 in the first primary-side sub-circuit are disposed adjacent to the transformer assembly 10 and adjoin the second side edge 102 of the first transformer magnetic core. Primary switches Q7 and Q8 in the second primary-side sub-circuit are disposed adjacent to the transformer assembly 20 and adjoin the second side edge 202 of the second transformer magnetic core. The primary-side winding and the secondary-side winding are arranged in the circuit substrate 1 and are copper foils in or on the surface of the printed circuit board. The circuit substrate 1 further comprises a plurality of hole grooves for the transformer side column and the transformer winding column to pass through, and the transformer magnetic core are assembled to the primary-side winding and the secondary-side winding from the upper surface 1-1 and the lower surface 1-2, respectively.

As shown in FIG. 5B, a bottom view of the power conversion device, the position of a lower magnetic core of the first transformer assembly 10 is perpendicular to the position of an upper magnetic core; the position of a lower magnetic core of the second transformer assembly 20 is perpendicular to the position of an upper magnetic core; the inductor assemblies 30 & 40 & 50 are arranged on the lower surface 1-2, and are sequentially arranged according to the order of the inductor assembly 40, the transformer assembly 10, the inductor assembly 30, the transformer assembly 20 and the inductor assembly 50; and the inductor assembly 30 is arranged adjacent to the third side edge 103 of the transformer assembly 10 and the third side edge 203 of the transformer assembly 20. Both the first side edge and the third side edge of the transformer assemblies 10 and 20 are provided with an inductor winding metal column and a GND metal column. In the present embodiment, both the inductor winding metal column and the GND metal column are implemented by copper blocks, but are not limited thereto, but may also be other conductive metal blocks. The bottom surfaces of the inductor winding metal column and the GND metal column are fixed on the lower surface 1-2 by soldering, and are electrically connected to the wiring in the circuit substrate 1. The inductor magnetic cores 31, 41 and 51 are respectively sleeved on the inductor winding metal columns, so that each inductor winding metal column is passed through the corresponding window of the inductor magnetic core. A top surface of the inductor winding metal column is an output positive terminal portion Vo+, and a top surface of the GND metal column is a GND terminal portion. At least one GND metal column is disposed adjacent to each inductor core. In the present embodiment, GND metal columns are disposed on two opposite sides of each inductor magnetic core. The lower surface 1-2 further comprises an input region 122 disposed adjacent to the second side edge 102 of the first transformer magnetic core or the second side edge 202 of the second transformer magnetic core. The projection of the input region 122 on the upper surface 1-1 at least partially overlaps with the input region 121. Primary-side capacitors C1 & C2 & C3 & C4, an input positive connector Vin+, an input negative connector Vin-, and a signal connector Sig are all disposed in the input region 122. The primary-side capacitors C1 and C2 are disposed adjacent to the transformer assembly 10, and projections of the primary-side capacitors C1 & C2 at least partially overlap with the primary-side switches Q1 & Q2 on the upper surface 1-1. The primary-side capacitors C3 and C4 are disposed adjacent to the transformer assembly 20, and projections of the primary-side capacitors C3 & C4 at least partially overlap with the primary-side switches Q7 & Q8 on the upper surface 1-1.

The power conversion device disclosed in the present application further comprises a capacitor adapter board 2, as shown in FIGS. 6A to 6D. FIG. 6A is a three-dimensional schematic diagram of a top surface of a power conversion device, FIG. 6B is a three-dimensional schematic diagram of a bottom surface of the power conversion device, FIG. 6C is an exploded schematic diagram of a top surface of the power conversion device, and FIG. 6D is an exploded schematic diagram of a bottom surface of the power conversion device. The capacitor adapter board 2 comprises an upper surface 2-1 and a lower surface 2-2 which are opposite to each other, and the control element 250 is provided on the upper surface 2-1. The control element may be a control chip or an MCU. In the present embodiment, the control element 250 is the MCU. The setting position of the control element 250 is arranged adjacent to the signal connector Sig. The other positions of the upper surface 2-1 can be set an output capacitor Co according to actual requirements, and the number, capacitance, size or setting position of the output capacitor can be designed according to actual requirements. The upper surface 2-1 further comprises inductor regions 253, 254 and 255, and the inductor regions 253 & 254 & 255 are respectively used for accommodating the inductor assemblies 30 & 40 & 50, and can also be used for providing an output positive pad and an output negative pad for soldering with the output positive terminal portion Vo+ and the GND terminal portion. The upper surface 2-1 further comprises an input positive pad, an input negative pad, and a signal pad, which are respectively disposed corresponding to the input positive connector Vin+, the input negative connector Vin-, and the signal connector Sig.

The lower surface 2-2 of the capacitor adapter board 2 is used for providing a BGA array. The BGA array is electrically connected to the pads of the upper surface 2-1 by means of internal wiring or vias of the capacitor adapter board 2, and the BGA array is used for transferring input/output power, part of control signals, or sampling signals. The arrangement of the BGA array can be designed according to actual requirements, so as to meet the demands of different customers.

In the present application, the inductor winding can also be implemented in a boss manner. In detail, the boss (not shown) is provided on the lower surface 1-2 of the circuit substrate 1, a hole is punched in the boss along the direction perpendicular to the circuit substrate 1, side edge electroplating is performed on a hole wall, and the inductor magnetic core covers the boss to implement the inductor assembly. In addition, the inductor assembly can also be implemented in an integrated manner, and the inductor magnetic core and the inductor winding are pressed together. The implementation methods of the above inductor assembly enable the inductor winding to be perpendicular to the circuit substrate 1, thereby effectively reducing the conduction loss.

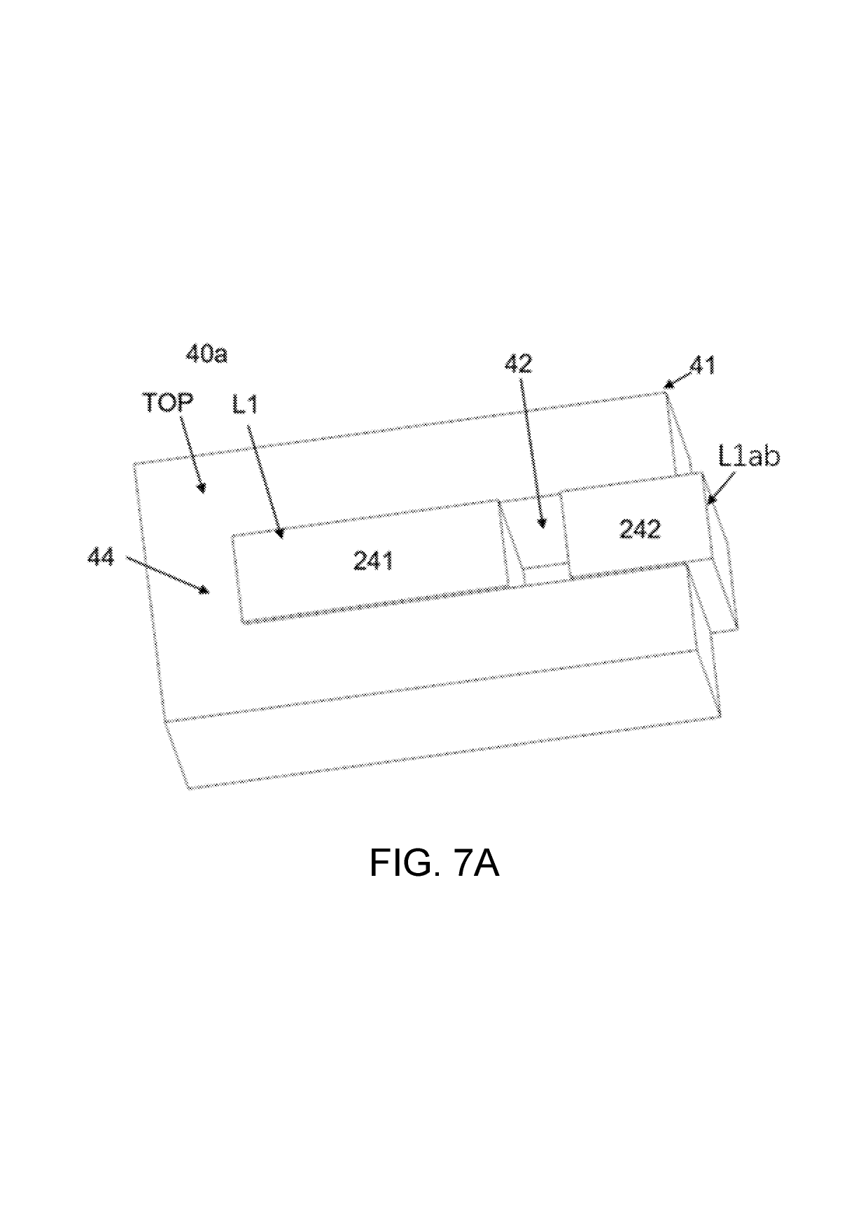

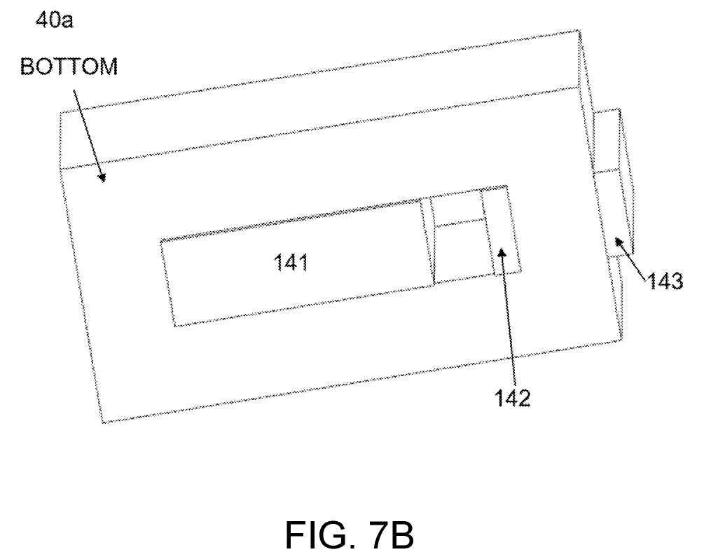

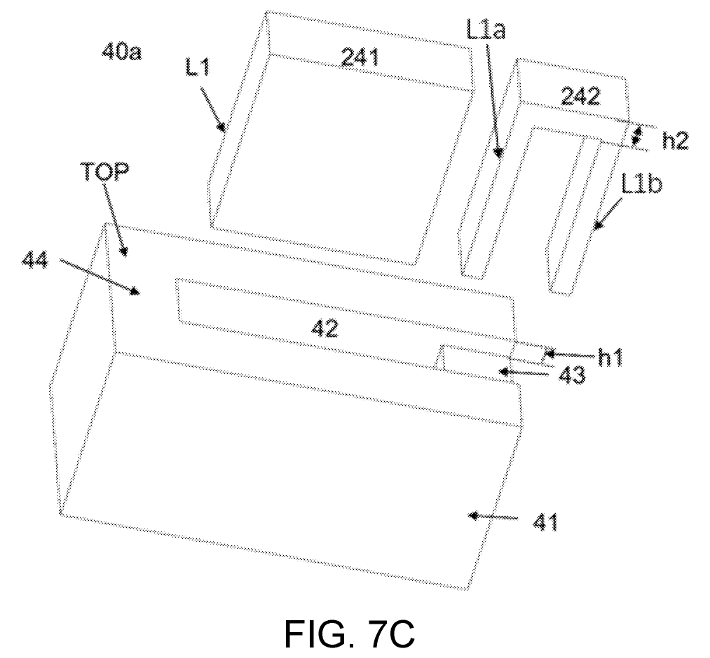

Corresponding to the inductor assembly including auxiliary windings, the structure of inductor assemblies 40 & 50 are used as an example to illustrate its implementation method. Referring to FIGS. 7A - 7C, FIG. 7A is a top view of the inductor assembly 40a, FIG. 7B is a bottom view of the inductor assembly 40a, and FIG. 7C is a schematic top exploded view of the inductor assembly 40a. The inductor assembly 40a comprises an inductor magnetic core 41, an output inductor winding L1, and an auxiliary assembly L1ab. The inductor magnetic core 41 comprises a window 42, a first vertical frame 43, a second vertical frame 44 and two horizontal frames; the positions of the first vertical frame 43 and the second vertical frame 44 are opposite. A height of the output inductor winding is the same as a height of the auxiliary assembly; the output inductor winding L1 is in an "I" shape, and is disposed through the window 42 and adjacent to the second vertical frame 44; furthermore, the output inductor winding L1 can be attached to the second vertical frame 44. A top end portion of the output inductor winding L1 is an output positive terminal portion 241, and is fixed and electrically connected to the capacitor adapter board 2. A bottom end portion 141 of the output inductor winding L1 is fixed and electrically connected to the circuit substrate 1. The auxiliary assembly L1ab is in a "n" shape, the auxiliary assembly L1ab is spanned over the first vertical frame 43, and comprises two vertical portions, one horizontal portion, a top end portion 242, and bottom end portions 142 & 143, wherein the two vertical portions are respectively an auxiliary winding L1a and an auxiliary connector L1b; the auxiliary winding L1a and the output inductor winding L1 are disposed in the window 42, and the auxiliary connector L1b is provided with the outer side of the magnetic core. The top end portion 242 is electrically connected to other auxiliary assemblies or the series inductor Lc by means of the capacitor adapter board 2, or is connected to a fixed potential point such as GND or Vo+. The bottom end portions 142 & 143 are electrically connected to other auxiliary assemblies or the series inductor Lc by means of the circuit substrate 1, or are connected to fixed potential points such as GND or Vo+. In another embodiment, the top end portion 242 of the auxiliary assembly L1ab is only soldered and fixed to the capacitor adapter board, and is not electrically connected; or the top of the auxiliary assembly L1ab may not include the top end portion 242, and the electrical connection is realized only through the bottom end portions 142 & 143. In order to ensure the flatness of the top end portion 241 of the output inductor winding L1 and the top end portion 242 of the auxiliary assembly L1ab, and the flatness of the bottom end portion 141 of the inductor winding L1 and the bottom end portions 142 & 143 of the auxiliary assembly L1ab, the first vertical frame 43 is cut a groove so that the top surface of the first vertical frame 43 is lower than the top surface of the other portions; In the present embodiment, a depth of the groove is h1, and a thickness of the auxiliary assembly L1ab is h2, so that h1 ≥ h2, that is, the above requirements can be met. There is a gap between the output inductor winding L1 and the auxiliary winding L1a, and there is no magnetic conductive material or a conductive material in the gap.

The inductor assembly comprising the auxiliary assembly may use a discrete inductor, first respectively manufacturing the inductor magnetic core, the output inductor winding and the auxiliary assembly; and then assembling the inductor magnetic core, the output inductor winding and the auxiliary assembly as a whole. First, the output inductor winding and the auxiliary assembly can also be soldered to a specific position of the printed circuit board, and then the inductor magnetic core s is assembled; the advantage is that the production cost is low, but the assembly tolerance is large.

In another embodiment, an integrated inductor may be employed. First, making the inductor magnetic core, the output inductor winding and the auxiliary assembly into a molded inductor, and then soldering and fixing on the substrate. The output inductor winding and the auxiliary assembly herein can be made of metal parts, or can be realized by copper electroplating on the side wall of the molded magnetic core. The advantage of the present embodiment is that the assembly tolerance is small, the obtained performance is better, and the assembly is convenient; however, the manufacturing cost is high.

In another embodiment, hybrid inductor may also be employed. First, the inductor magnetic core and the output inductor winding are integrated and formed to a unit, and then the auxiliary assembly is assembled; or the inductor magnetic core and the auxiliary assembly are integrated and formed to a unit, and then the output inductor winding is assembled.

In the present application, the inductor assembly is vertically mounted between the circuit substrate 1 and the capacitor adapter board 2, and is electrically connected by means of soldering; during the assembly process of the power conversion device, adhesive can be respectively applied to the top surface and the bottom surface of the inductor magnetic core, and the top surface and the bottom surface of the inductor magnetic core are respectively fixed to the circuit substrate 1 and the capacitor adapter board 2 by means of the adhesive, and the heat generated by the inductor magnetic core is dissipated to the circuit substrate 1 and the capacitor adapter board 2 by means of the adhesive.

### Embodiment 2

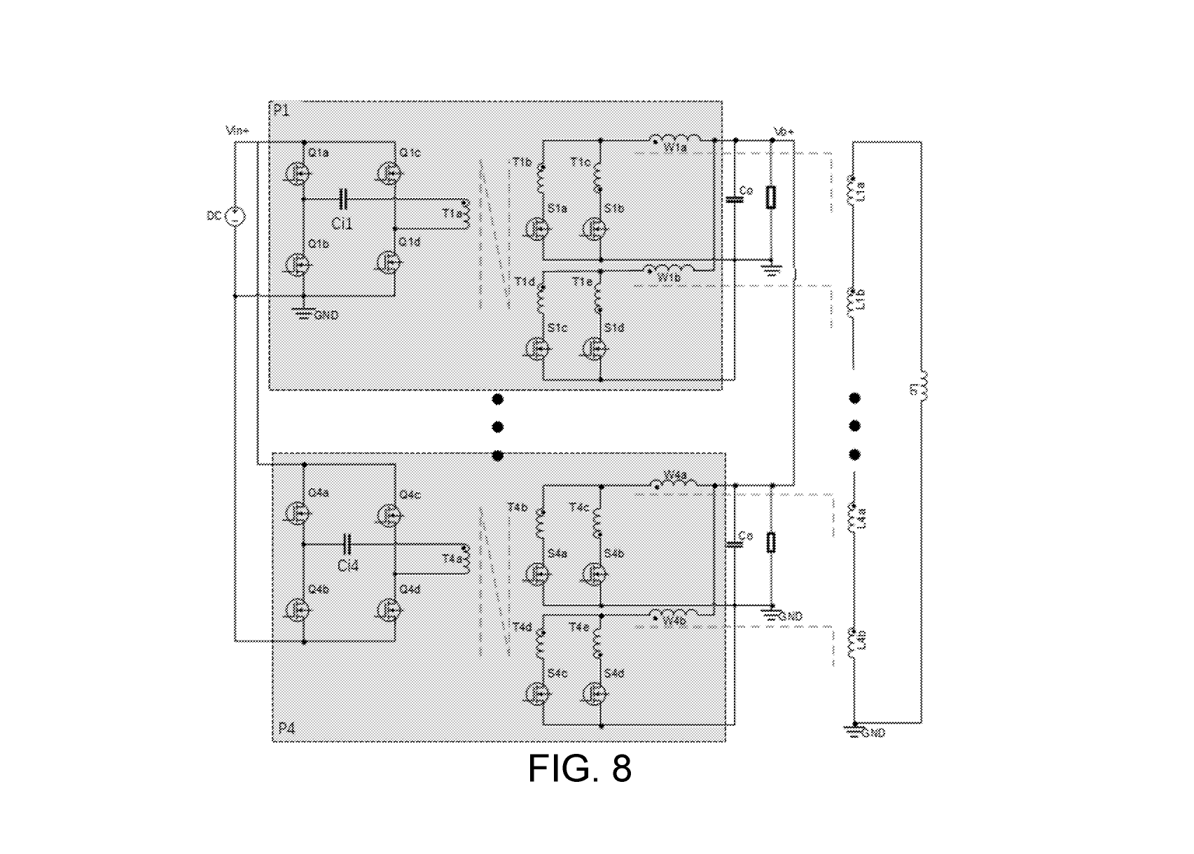

Another single-stage power conversion circuit, as shown in FIG. 8, includes four-phase power circuits P1, P2, P3, and P4. Each phase power circuit includes a primary-side sub-circuit and a secondary-side sub-circuit. Each primary-side sub-circuit is a full-bridge circuit, and each secondary-side sub-circuit includes two center-tap circuits electrically connected in parallel. Taking a first phase power circuit as an example, a first primary-side sub-circuit comprises four primary-side switches Q1a, Q1b, Q1c and Q1d; wherein the primary-side switches Q1a and Q1b are electrically connected in series to form a first switch bridge arm, and the primary-side switches Q1c and Q1d are electrically connected in series to form a second switch bridge arm; Here, after the first switch bridge arm and the second switch bridge arm are electrically connected in parallel, and connected between an input positive terminal Vin+ and an input negative terminal (i.e. a ground terminal GND). The first primary-side sub-circuit further comprises a DC-blocking capacitor Ci1 and a first primary-side winding T1a. The DC-blocking capacitor Ci1 and the first primary-side winding T1a are electrically connected in series and then connected between the midpoint of the two switch bridge arms. The advantage of using the full-bridge circuit in the primary-side sub-circuit is that it allows for the use of a simple and easy-to-implement primary-side current detection circuit, and the primary-side current detection signal has good real-time performance, low distortion, and high detection precision.

A first secondary-side sub-circuit comprises a first center-tap circuit and a second center-tap circuit; the first center-tap circuit comprises synchronous rectifier switches S1a and S1b, a first secondary-side winding T1b and a second secondary-side winding T1c, and an output inductor W1a; the second center-tap circuit includes synchronous rectifier switches S1c and S1d, a third secondary-side winding T1d and a fourth secondary-side winding T1e, and an output inductor W1b. The connection mode of each center-tap circuit may be referred to in FIGS. 1A and 1B, and details are not described herein again. The primary-side winding T1a and the secondary-side winding T1b, T1c, T1d, and T1e in the first phase power circuit P1 are coupled in the same magnetic core to form a first transformer T1.

The input terminals of the eight output inductors W1a & W1b…& W4a & W4b in the four-phase power circuit are electrically connected to one center-tap of the secondary-side sub-circuit, respectively; and the output terminals of the eight output inductors are electrically connected to the output positive terminal Vo+. The four-phase power circuit further comprises eight auxiliary windings L1a & L1b…& L4a & L4b, wherein the auxiliary winding L1a is coupled to the first output inductor W1a, the auxiliary winding L1b is coupled to the second output inductor W1b, and so on, the auxiliary winding L4a is coupled to the first output inductor W4a, and the auxiliary winding L4b is coupled to the second output inductor W4b. And a first end of each auxiliary winding and an input terminal of the coupled output inductor are with the same polarity, and are marked as point ends. The eight auxiliary windings are sequentially connected in series in a forward direction to form a closed auxiliary loop; in another embodiment, the eight auxiliary windings are sequentially connected in series in a forward direction, and then connected to an external inductor Lc to form a closed auxiliary loop. The forward direction is that a point end of one auxiliary winding is short-circuited to the non-point end of another auxiliary winding.

The four-phase power circuit uses eight pulse width control signals, and the eight pulse width control signals are sequentially staggered by 45 degrees. Two pulse width control signals are used in the same phase power circuit, and the two pulse width control signals are staggered by 180 degrees. The voltages at the two ends of the first secondary-side winding (i.e. TW1b, TW2b, TW3b and TW4b) in the four-phase power circuit are sequentially staggered by 45 degrees. By analogy, the voltage at the two ends of the second secondary-side winding in the four-phase power circuit, or the voltage at the two ends of the third secondary-side winding, or the voltage at the two ends of the fourth secondary-side winding are sequentially staggered by 45 degrees.

The input terminals of the four-phase power circuit are electrically connected in parallel, and the output terminals of the four-phase power circuit are electrically connected in parallel. In this way, the output power of the power conversion device is improved, and the high-power requirement of a load is met. In addition, under steady-state operation, the voltage at the two ends of eight auxiliary windings coupled to eight output inductors are sequentially staggered by 45 degrees, so that the ac voltage amplitude after the eight auxiliary windings are connected in series is small, so that the ac current amplitude of the auxiliary closed loop is small, and the influence on ac current amplitudes of the eight output inductors is small.

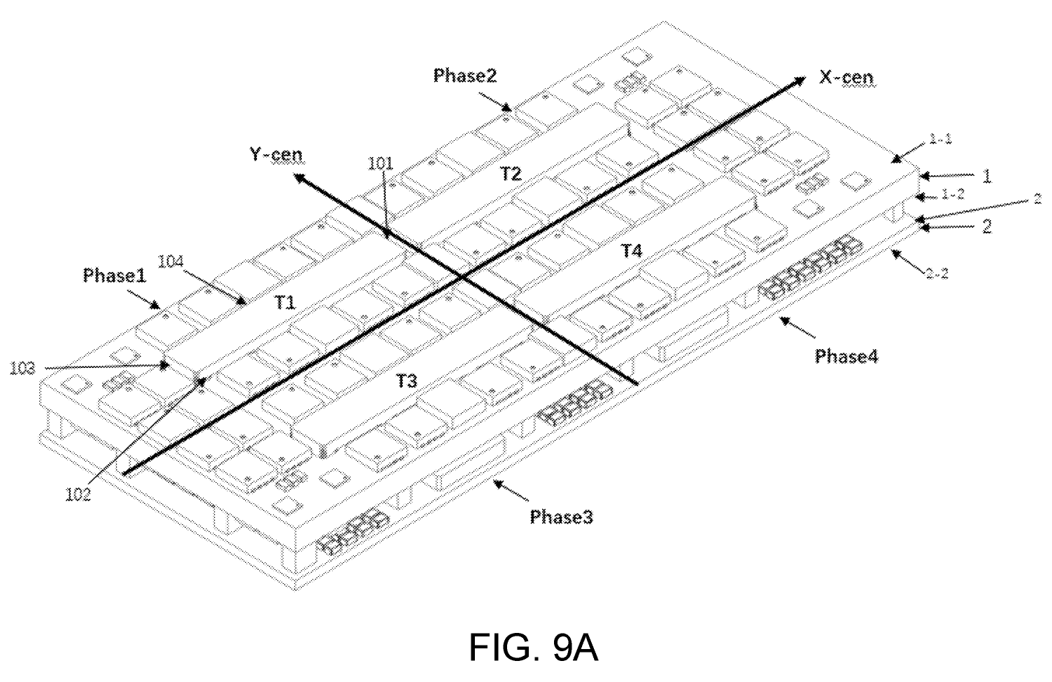

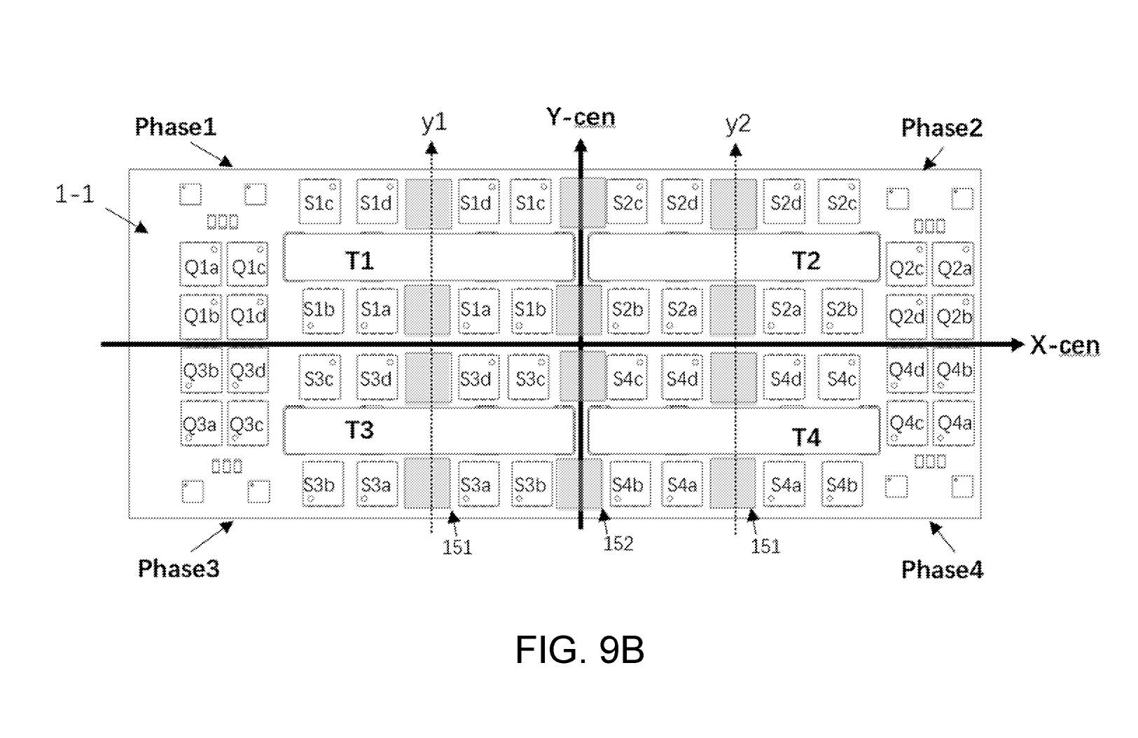

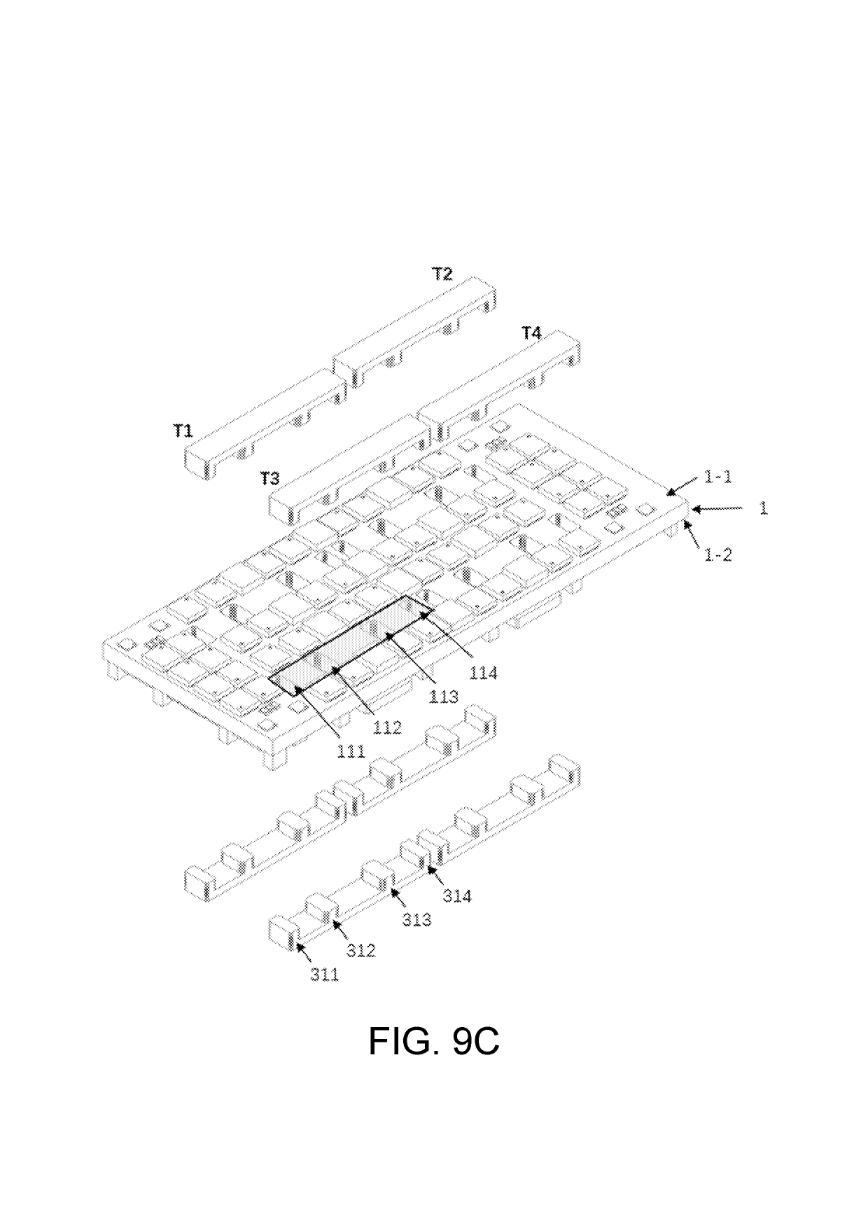

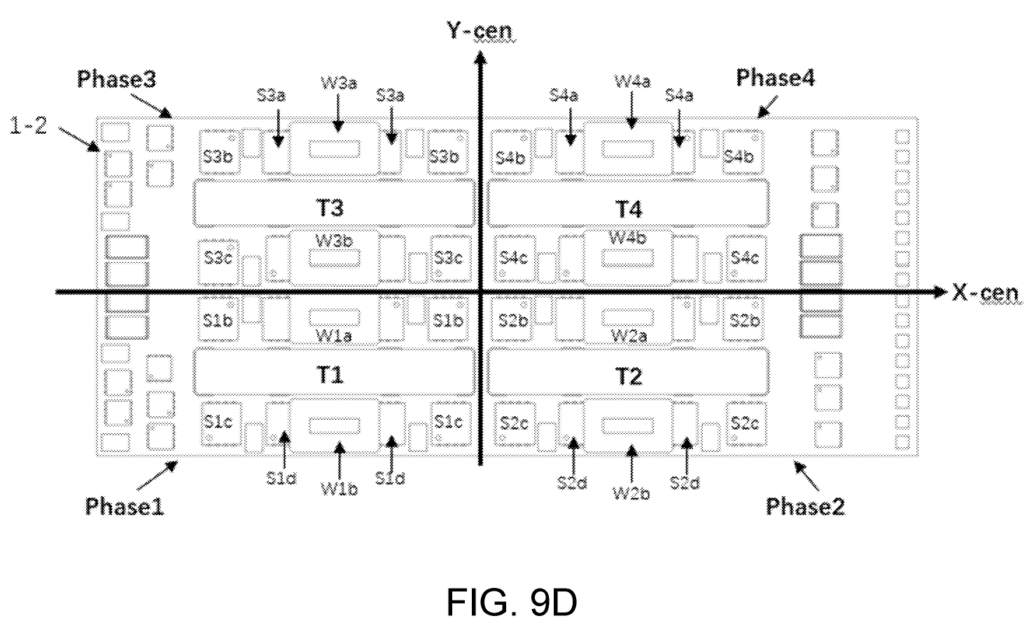

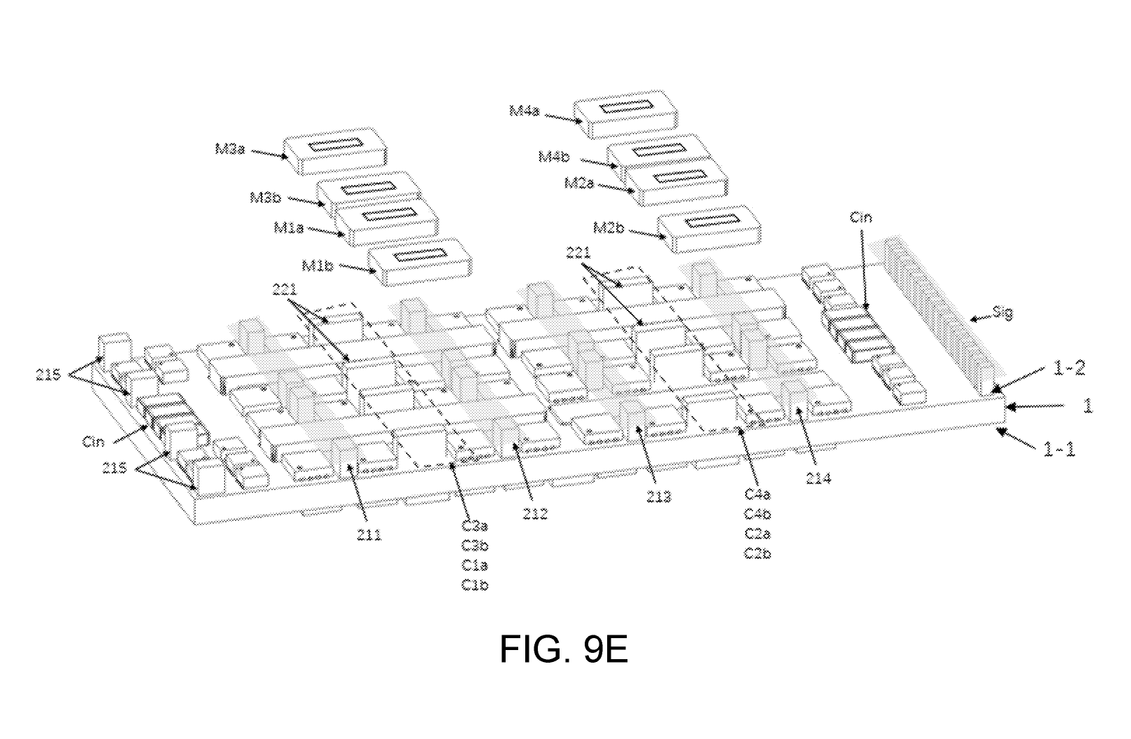

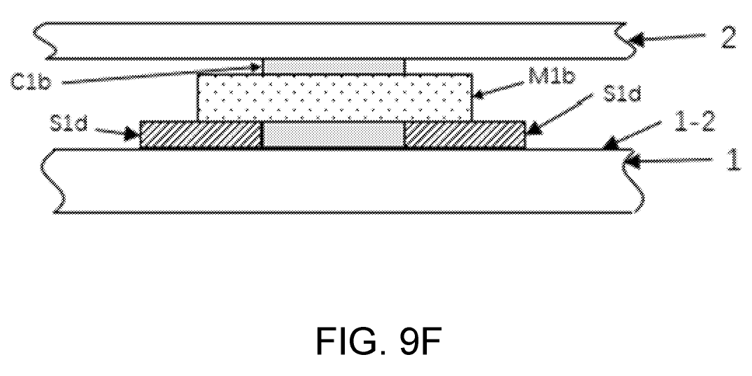

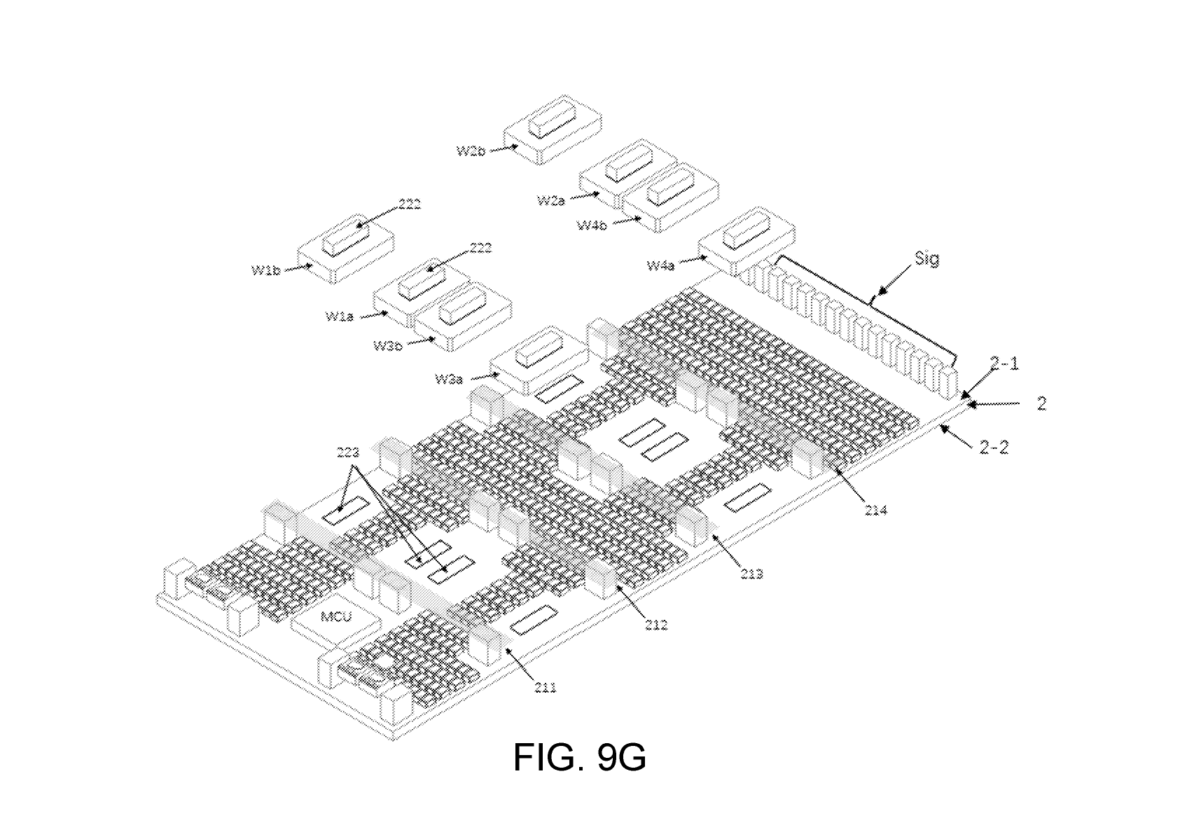

A schematic structural diagram of a power conversion device using the four-phase power circuit is shown in FIGS. 9A to 9G. As shown in FIG. 9A, a schematic three-dimensional structure diagram of a power conversion device includes a circuit substrate 1 and an adapter board 2, wherein a lower surface 1-2 of the circuit substrate 1 is adjacent to an upper surface 2-1 of the adapter board 2. The first transformer T1, the second transformer T2, the third transformer T3 and the fourth transformer T4 are arranged on the circuit substrate 1. The upper surface of the circuit substrate 1 has a symmetry axis X-cen in the X direction and a symmetry axis Y-cen in the Y-direction; the symmetry axes X-cen and the symmetry axes Y-cen are not only present on the upper surface 1-1 of the circuit substrate 1, but also on the lower surface 1-2 of the circuit substrate 1 and the upper surface 2-1 of the adapter board 2. The circuit substrate 1 are divided into four regions by the symmetry axes X-cen and the symmetry axes Y-cen, which are regions Phase 1, Phase 2, Phase 3, and Phase 4, respectively; the four regions are arranged clockwise according to the sequence of Phase 1, Phase 2, Phase 4, and Phase 3. A first region Phase 1 is used for setting the first phase power circuit P1; a second region Phase 2 is used for setting the second phase power circuit P2; a third region Phase 3 is used for setting the third phase power circuit P3; a fourth region Phase 4 is used for setting the fourth phase power circuit P4, wherein the first phase power circuit P1 and the second phase power circuit P2 are arranged on one side of the symmetry axis X-cen, and are symmetrically arranged along the symmetry axis Y-cen; the third phase power circuit P3 and the fourth phase power circuit P4 are arranged on the other side of the symmetry axis X-cen, and are symmetrically arranged along the symmetry axis Y-cen; the first phase power circuit P1 and the third phase power circuit P3 are symmetrically arranged along the symmetry axis X-cen, and the second phase power circuit P2 and the fourth phase power circuit P4 are symmetrically arranged along the symmetry axis X-cen.

FIG. 9B is a top view of the power conversion device; FIG. 9C is a top exploded view of the circuit substrate 1; FIG. 9D is a bottom view of the circuit substrate 1; FIG. 9E is a bottom exploded view of the circuit substrate 1; FIG. 9F is a partial side view of the power conversion device; and FIG. 9G is a top exploded view of the adapter board 2. One side of each transformer adjacent to the symmetry axis Y-cen is a first side 101, and the side opposite to the first side is the third side 103; one side of each transformer adjacent to the symmetry axis X-cen is the second side 102, and the side opposite to the second side is the fourth side 104. The magnetic core of each transformer comprises a first winding column 312, a second winding column 313, a first side column 311 and a second side column 314; and arranged in the same direction according to the order of the first side column 311, the first winding column 312, the second winding column 313, and the second side column 314; and a channel between two adjacent magnetic columns penetrates through the second side and the fourth side of the transformer. The first side column 311, the first winding column 312, the second winding column 313, and the second side column 314 are respectively passed through holes 111, 112, 113 and 114 (as shown in FIG. 9C) provided on the circuit substrate 1; the upper magnetic cover and the lower magnetic cover of the magnetic core are respectively assembled to the circuit substrate 1 from the upper surface 1-1 and the lower surface 1-2 of the circuit substrate 1, and the primary-side winding and the secondary-side winding are provided in the circuit substrate.

The arrangement of each phase power circuit is similar, the arrangement of the first phase power circuit P1 is taken as an example for description, the primary-side switches Q1a & Q1b & Q1c & Q1d are arranged in an array of 2 × 2, and the four primary-side switches are disposed adjacent to the third side 103 of the first transformer T1; and the upper switches Q1a and Q1c are arranged adjacent to the fourth side 104 of the first transformer T1, and the lower switches Q1b and Q1d are arranged adjacent to the symmetry axis X-cen. The synchronous rectifier switches S1a and S1b in the first center-tap circuit are arranged on one side of the first transformer T1 (for example, the second side 102); the synchronous rectifier switches S1c and S1d in the second center-tap circuit are arranged on the other side of the transformer T1 (for example, the fourth side 104); Of course, as long as the synchronous rectifier switches in the first center-tap circuit and the synchronous rectifier switches in the second center-tap circuit are respectively arranged on the opposite second side and the fourth side of the transformer; in other words, the synchronous rectifier switches in the first center-tap circuit and the synchronous rectifier switches in the second center-tap circuit are respectively arranged adjacent to the two openings of a magnetic core channel. In addition, the synchronous rectifier switches in each center-tap circuit include two groups, which can be set in detail with reference to the synchronous rectifier switches in FIG. 5A, which will not be repeated here. A metal block 151 is disposed between the two groups of synchronous rectifier switches (the material can be a copper, aluminum or other materials with good thermal conductivity characteristics), and is used for dissipating heat generated by the synchronous rectifier switches or the secondary-side winding loss. Similarly, the metal columns 152 are disposed along the symmetry axis Y-cen, and are disposed between the synchronous rectifier switches of adjacent to two phase power circuits for dissipating heat generated by the synchronous rectifier switches.

In the present embodiment, the first phase power circuit P1 and the third phase power circuit P3 are arranged on one side of the symmetry axis Y-cen, and are symmetrically arranged along the symmetry axis X-cen; and the transformer and the switch in the third phase power circuit and the transformer and the switch in the first phase power circuit satisfy a mirror symmetry relationship; the advantages are that the first phase power circuit and the third phase power circuit are staggered by 90 degrees; the primary-side switches in the two phase power circuit are arranged adjacent to each other, so that the input ripple current of the primary-side circuit can be reduced, and the size of an input filter is reduced; in addition, the secondary-side synchronous rectifier switches are placed adjacent to each other, so that the output ripple current of the secondary-side circuit can be reduced, and the size of the output filter can be reduced. Similarly, the second phase power circuit P2 and the fourth phase power circuit P4 are arranged on the other side of the symmetry axis Y-cen, and are symmetrically arranged along the symmetry axis X-cen. The transformer and the switch in the second phase power circuit and the fourth phase power circuit also adopt a mirror arrangement, and the same technical benefits can also be obtained.

As shown in FIGS. 9D and 9E , the lower surface of the circuit substrate, the lower surface 1-2 of the circuit substrate 1 is also provided with synchronous rectifier switches of the four-phase power circuit, and the synchronous rectifier switches provided on the lower surface 1-2 are in one-to-one perpendicular correspondence with the synchronous rectifier switches arranged on the upper surface 1-1, and are electrically connected in parallel by means of the circuit substrate; here, the one-to-one perpendicular correspondence refers to that the projection on the upper surface of each synchronous rectifier switch disposed on the lower surface 1-2 at least partially overlaps with the projection of the corresponding synchronous rectifier switch on the corresponding upper surface 1-1. Output inductor W1a & W1b… & W4a & W4b are disposed on the lower surface 1-2; each output inductor includes an inductor magnetic core and an inductor winding, the eight inductor magnetic cores are respectively M1a & M1b… & M4a & M4b, and the eight inductor windings are respectively C1a & C1b… & C4a & C4b; and each inductor winding is passed through a central hole of the inductor magnetic core. Similarly, on the lower surface 1-2 ,the synchronous rectifier switches in each center-tap circuit comprises two groups, and the inductor windings are arranged between the two groups of synchronous rectifier switches. An output terminal surface 221 of each inductor winding is fixed and electrically connected to a pad 223 provided on the upper surface 2-1 of the adapter board 2, and each output terminal surface 221 is electrically connected to the output positive terminal Vo+ of the power conversion device. An input terminal surface 222 of each inductor winding is fixed to a pad provided on the lower surface 1-2 of the circuit substrate 1, and is electrically connected to a corresponding secondary-side winding. In FIGS. 9E and 9G , grounding metal blocks 211 & 212 & 213 & 214 are respectively arranged between two synchronous rectifier switches in each group of synchronous rectifier switch, two ends of the grounding metal blocks are respectively fixed to the circuit substrate 1 and the adapter board 2, and a GND network on the circuit substrate 1 and a GND network on the adapter board 2 are electrically connected. The lower surface 1-2 of the circuit substrate 1 is further provided with an input terminal 215, a signal terminal Sig, and an input capacitor Cin. The input capacitor Cin is disposed adjacent to the primary-side switch, thereby reducing the parasitic impedance of the input capacitor Cin and the closed loop formed by the primary-side switch bridge arm. The signal electrical connector Sig and the input terminal 215 are arranged on two opposite sides, the signal electrical connector Sig is fixed to the circuit substrate 1 and the adapter board 2, and signal transmission between the circuit substrate 1 and the adapter board 2 is realized; the input terminal 215 is fixed to the circuit substrate 1 and the adapter board 2, and input power transmission between the circuit substrate 1 and the adapter board 2 is realized.

FIG. 9F shows a side cross-sectional view of an inductor and an adjacent to the synchronous rectifier switch, the output inductor W1b is taken as an example for description; the inductor magnetic core M1b is sleeved on the inductor winding C1b, and a gap between the inductor magnetic core M1b and the circuit substrate 1 is provided with the synchronous rectifier switch S1d. The structure can make full use of the space in the height direction of the power conversion device, and further reduce the area of the power conversion device. In addition, a gap between the inductor magnetic core M1b and the adapter board 2 is high enough, and the output capacitor Co can be disposed in the gap.

FIG. 9G is a schematic diagram of an upper surface of the adapter board, the microprocessor MCU is disposed on the upper surface 2-1 to generate a pulse width control signal, and the signal electrical connector Sig transmits the pulse width control signals to the circuit substrate 1. The upper surface 2-1 is provided with as many output capacitors Co as possible, thereby improving the dynamic response capability of the power conversion device.

The switch disclosed by the application can be used for realizing the functions of the switch disclosed by the application, such as a Si MOSFET, SiC MOSFET, GaN MOSFET or IGBT MOSFET.

The power supply module device according to the embodiment can be an independent module or a part of the electronic device, and can meet the technical features and advantages disclosed by the application.

The " equal " or " same " or " equal to " disclosed by the application needs to consider the parameter distribution of engineering, and the error distribution is within +/-30%; and the included angle between the two line segments or the two straight lines is less than or equal to 45 degrees; the included angle between the two line segments or the two straight lines is within the range of [ 60, 120 ]; and the definition of the phase error phase also needs to consider the parameter distribution of the engineering, and the error distribution of the phase error degree is within +/-30%.

The embodiments in the specification are described in a progressive manner, each embodiment focuses on the difference from other embodiments, and the same similar parts between the embodiments can be referred to each other.

The above description of the disclosed embodiments enables a person skilled in the art to implement or use the present application. Various modifications to these embodiments will be readily apparent to those skilled in the art, and the generic principles defined herein may be implemented in other embodiments without departing from the spirit or scope of the application. Thus, the present application will not be limited to the embodiments shown herein but is to be accorded the widest scope consistent with the principles and novel features disclosed herein.

What is claimed is:

1. A single-stage power conversion device, comprising an input positive terminal, an input negative terminal, an output positive terminal, an output negative terminal, at least one primary-side sub-circuit, at least one first synchronization unit, at least one second synchronization unit, at least two output inductors, and a closed loop; each primary-side sub-circuit comprises a primary-side winding; each synchronization unit comprises at least one secondary-side winding; one primary-side winding and the secondary-side winding of one first synchronization unit and the secondary-side winding of one second synchronization unit are coupled;
Each synchronization unit comprises a unit positive terminal, a unit negative terminal; and the unit negative terminal is electrically connected to the output negative terminal;
A first end of each of the output inductors is electrically connected to the unit positive terminal of one synchronization unit, and a second end of each of the output inductors is electrically connected to the output positive terminal;
The closed loop includes at least two auxiliary windings and a series inductor connected in series, each auxiliary winding is coupled with one of the at least two output inductors; the series inductor is an external inductor, a parasitic inductance, or a combination of the external inductor and the parasitic inductance.

2. The single-stage power conversion device of claim 1, wherein a coupling coefficient between each auxiliary winding and one output inductor is greater than 0.5; a first end of each auxiliary winding and the first end of the output inductor coupled to each other are dotted terminals, and a second end of one auxiliary winding is sequentially connected to the first end of another auxiliary winding.

3. The single-stage power conversion device of claim 1, wherein each of the synchronization units further comprises at least one synchronous rectifier switch; a first end of each secondary-side winding is electrically connected to the unit positive terminal, and a second end of each secondary-side winding is electrically connected to a drain of one synchronous rectifier switch; and a source of each synchronous rectifier switch is electrically connected to the unit negative terminal.

4. The single-stage power conversion device of claim 1, wherein each primary-side sub-circuit further comprises one switch bridge arm and one capacitor bridge arm; the switch bridge arm comprises two primary-side switches, and the two primary-side switches are connected to a midpoint of the switch bridge arm; the capacitor bridge arm includes two primary-side capacitors connected to a midpoint of the capacitor bridge arm; the primary-side winding is connected between the midpoint of the switch bridge arm and the midpoint of the capacitor bridge arm, a first end of the primary-side winding is electrically connected to the midpoint of the switch bridge arm, and a second end of the primary-side winding is electrically connected to the midpoint of the capacitor bridge arm.

5. The single-stage power conversion device of claim 1, wherein each primary-side sub-circuit further comprises two switch bridge arms; each switch bridge arm comprises two primary-side switches, and the two primary-side switches of each switch bridge arm are connected to a midpoint of the one switch bridge arm; and the primary-side winding is connected between the midpoints of the two switch bridge arms.

6. The single-stage power conversion device of claim 1, comprising two primary-side sub-circuits, two first synchronization units, two second synchronization units, and four output inductors; each of the synchronization units comprises two secondary-side windings and two synchronous rectifier switches; the closed loop comprises four auxiliary windings and the series inductor connected in series, and each auxiliary winding is coupled to one of the four output inductors; and each primary-side sub-circuit comprises a primary-side upper switch and a primary-side lower switch.

7. The single-stage power conversion device of claim 6, wherein the single-stage power conversion device is controlled by using eight control signals; a first control signal is used for controlling the turn-on and turn-off of the primary-side upper switch of one primary-side sub-circuit; a second control signal is used for controlling the turn-on and turn-off of the primary-side upper switch of the other primary-side sub-circuit; a third control signal is used for controlling the turn-on and turn-off of the primary-side lower switch of one primary-side sub-circuit; a fourth control signal is used for controlling the turn-on and turn-off of the primary-side lower switch of the other primary-side sub-circuit; the duty cycles of the first control signal, the second control signal, the third control signal, and the fourth control signal are equal, and the four control signals are sequentially staggered by 90 degrees.

8. The single-stage power conversion device of claim 7, wherein a fifth control signal is complementary to the first control signal, and is used for controlling the turn-on and turn-off of one synchronous rectifier switch of one first synchronization unit and one synchronous rectifier switch of one second synchronization unit; a sixth control signal is complementary to the second control signal, and is used for controlling the turn-on and turn-off of one synchronous rectifier switch of the other first synchronization unit and one synchronous rectifier switch of the other second synchronization unit; a seventh control signal is complementary to the third control signal, and is used for controlling the turn-on and turn-off of the other synchronous rectifier switch of one first synchronization unit and the other synchronous rectifier switch of one second synchronization unit; a eighth control signal is complementary to the fourth control signal, and is used for controlling the turn-on and turn-off of the other synchronous rectifier switch of the other first synchronization unit and the other synchronous rectifier switch of the other second synchronization unit.

9. A single-stage power conversion device, comprising a circuit substrate, two transformer assemblies, and three inductor assemblies, wherein the circuit substrate comprises an upper surface and a lower surface opposite to each other;
Each of the transformer assemblies comprises a primary-side winding, at least two secondary-side winding combinations, and a transformer magnetic core, wherein each inductor assembly comprises an inductor winding and an inductor magnetic core; the primary-side winding and the secondary-side winding combination are arranged within the circuit substrate and/or on the upper surface and/or the lower surface; the transformer magnetic core is respectively assembled to the primary-side winding and the secondary-side winding combination from the upper surface and the lower surface; each of the inductor assemblies is provided on the lower surface;
The transformer assemblies and the inductor assemblies are sequentially arranged according to the order of the inductor assembly, the transformer assembly, the inductor assembly, the transformer assembly, and the inductor assembly.

10. The single-stage power conversion device of claim 9, further comprising a primary-side switch and a secondary-side synchronous rectifier switch, wherein the primary-side switch is arranged on the same side of the inductor assembly and the transformer assembly, and the secondary-side synchronous rectifier switch is arranged between the inductor assembly and the transformer assembly.

11. The single-stage power conversion device of claim 10, wherein the transformer magnetic core comprises two transformer side columns, at least one transformer winding column, a first side edge and a third side edge opposite to each other, and a second side edge and a fourth side edge opposite to each other; the second side edge is located on the left side of the third side edge, and the fourth side edge is located on the right side of the third side edge; the third side edges of the two transformer magnetic cores are adjacent to each other; the two transformer side columns and the at least one transformer winding column are arranged along the third side edge; and a winding channel is provided between the transformer side column and the transformer winding column and between the transformer winding columns.

12. The single-stage power conversion device of claim 11, wherein a first end and a second end of the primary-side winding of one transformer assembly are both disposed adjacent to the third side edge or the first side edge of the magnetic core of the transformer, and a first end and a second end of the primary-side winding of the other transformer assembly are disposed adjacent to the first side edge or the third side edge of the transformer magnetic core; the first end of the primary-side winding of each transformer assembly is disposed adjacent to one transformer side column, and the second end of the primary-side winding of each transformer assembly is disposed adjacent to the other transformer side column; each primary-side winding is wound N turns around the transformer winding column in a first direction from the first end to the second end.

13. The single-stage power conversion device of claim 11, wherein each secondary-side winding combination comprises a first secondary-side winding unit and a second secondary-side winding unit; each of the secondary-side winding units comprises two secondary-side windings; four secondary-side windings in each secondary-side winding combination are passed through one winding channel once, and the turns ratio of each primary-side winding to the four secondary-side windings in one secondary-side winding combination is 2 * N: 1: 1: 1: 1.

14. The single-stage power conversion device of claim 13, wherein the second ends of the two secondary-side windings in the same secondary-side winding unit are short-circuited together to form a second end of the secondary-side winding unit; and two secondary-side windings in the same secondary-side winding unit are passed through different winding channels in the same direction, and the first end and the second end of each secondary-side winding are arranged on two opposite sides of the transformer magnetic core; and the second end of the first secondary-side winding unit and the second end of the second secondary-side winding unit are arranged on two opposite sides of the transformer magnetic core.

15. The single-stage power conversion device of claim 9, further comprising a first output inductor, a second output inductor, a third output inductor, and a fourth output inductor; the three inductor assemblies are respectively a first inductor assembly, a second inductor assembly and a third inductor assembly; the first inductor assembly comprises a rectangular-frame-shaped inductor magnetic core, a window and a winding of the first output inductor; the third inductor assembly comprises a rectangular-frame-shaped inductor magnetic core, a window, and a winding of the fourth output inductor; the second inductor assembly comprises a dual-window-shaped inductor magnetic core, two windows, a winding of the second output inductor, and a winding of the third output inductor; the two windows are shared a horizontal column; the second inductor assembly is disposed between the first inductor assembly and the third inductor assembly.

16. The single-stage power conversion device of claim 15, wherein the winding of each output inductor is passed through a corresponding window from front to back to reach a second end of the winding of the output inductor; the first end of the winding is in front of the window.

17. The single-stage power conversion device of claim 16, further comprising four auxiliary assemblies and a series inductor; each of the auxiliary assemblies comprises an auxiliary winding and an auxiliary connector; the auxiliary winding and the winding of the output inductor are disposed in the window; each auxiliary winding is passed through a corresponding window from front to back to a second end of the auxiliary winding, and is coupled to the winding of the output inductor; the four auxiliary windings are sequentially connected in a manner that the second end of one auxiliary winding is electrically connected to the first end of another auxiliary winding, and is electrically connected to the series inductor to form a closed loop; and the series inductor is an external inductor, a parasitic inductance, or a combination of the external inductor and the parasitic inductance.

18. The single-stage power conversion device of claim 11, wherein the transformer magnetic core of each of the transformer assemblies comprises two transformer winding columns; the two transformer winding columns are arranged between the two transformer side columns; a first end of each primary-side winding is arranged adjacent to one transformer side column and one transformer winding column, and a second end of each primary-side winding is arranged adjacent to the two transformer winding columns; and each primary-side winding is wound around the two transformer winding columns in an "8" shape from the first end to the second end.

19. The single-stage power conversion device of claim 18, wherein a specific winding manner of each primary-side winding from the first end to the second end is as follows: each primary-side winding is wound clockwise around one transformer winding column, and then wound counterclockwise around the other transformer winding column.

20. The single-stage power conversion device of claim 14, wherein the transformer magnetic core of each of the transformer assemblies comprises two transformer winding columns; the two transformer winding columns are arranged between the two transformer side columns; each of the transformer assemblies comprises four secondary-side winding combinations; each of the two secondary-side winding combinations satisfies mirror symmetry in the Y-axis direction; the four secondary-side winding combinations are respectively arranged around one transformer winding column; and second ends of the secondary-side winding units arranged on the same side of the transformer magnetic core are short-circuited.

21. The single-stage power conversion device of claim 20, wherein the secondary-side synchronous rectifier switch comprises a first secondary-side synchronous rectifier switch, a second secondary-side synchronous rectifier switch, a third secondary-side synchronous rectifier switch, and a fourth secondary-side synchronous rectifier switch; the first secondary-side synchronous rectifier switch and the third secondary-side synchronous rectifier switch satisfy mirror symmetry along the Y-axis direction; the second secondary-side synchronous rectifier switch and the fourth secondary-side synchronous rectifier switch satisfy mirror symmetry along the Y-axis direction; each secondary-side synchronous rectifier switch is disposed adjacent to and connected to the first end of the secondary-side winding.

22. The single-stage power conversion device of claim 11, wherein the upper surface of the circuit substrate comprises an input region; the input region is disposed adjacent to the second side edge of the transformer magnetic core; the primary-side switch is disposed in the input region; the primary-side switch comprises a first primary-side upper switch, a first primary-side lower switch, a second primary-side upper switch, and a second primary-side lower switch; the first primary-side upper switch and the first primary-side lower switch are disposed adjacent to one transformer assembly and disposed adjacent to the second side edge of the transformer magnetic core of the transformer assembly; the second primary-side upper switch and the second primary-side lower switch are disposed adjacent to the other transformer assembly and disposed adjacent to the second side edge of the transformer magnetic core of the other transformer assembly.

23. The single-stage power conversion device of claim 9, wherein both a first side and a third side of each transformer assembly are provided with an inductor winding metal column and a GND metal column; the inductor winding metal column is the inductor winding in the inductor assembly; and the GND metal column is a ground terminal of the single-stage power conversion device.

24. The single-stage power conversion device of claim 22, the lower surface of the circuit substrate also comprises an input region, and the input region of the lower surface of the circuit substrate is arranged adjacent to the second side edge of each transformer magnetic core; the projection of the input region on the lower surface of the circuit substrate on the upper surface at least partially overlaps the projection of the input region on the upper surface of the circuit substrate.

25. The single-stage power conversion device of claim 24, the input region on the lower surface of the circuit substrate comprises four primary-side capacitors; two primary-side capacitors of the four primary-side capacitors are disposed adjacent to one transformer assembly, and projections of the two primary-side capacitors on the upper surface at least partially overlap with the first primary-side upper switch and the first primary-side lower switch; the other two primary-side capacitors are disposed adjacent to the other transformer assembly, and projections of the other two primary-side capacitors on the upper surface at least partially overlap with the second primary-side upper switch and the second primary-side lower switch.

26. An inductor assembly, comprising an inductor magnetic core, an output inductor winding, and an auxiliary assembly; the inductor magnetic core includes a window and a frame surrounding the window, the frame includes a groove; the output inductor winding is in an "I" shape, and the output inductor winding is penetrated through the window; the auxiliary assembly is in an "n" shape, and the auxiliary assembly is spanned over the frame and is clamped in the groove; the auxiliary assembly includes an auxiliary winding and an auxiliary connector; and the auxiliary winding and the inductor winding are disposed in the window.

27. The inductor assembly of claim 26, wherein the output inductor winding comprises a top end portion and a bottom end portion are used for soldering and fixing and electrical connection to an external element ; the auxiliary assembly comprises two bottom end portions and a top surface, the two bottom end portions are used for soldering and fixing and electrical connection to an external element; and there is a gap between the output inductor winding and the auxiliary winding.

28. The inductor assembly of claim 27, wherein the bottom end portion of the output inductor winding is coplanar with the bottom end portion of the auxiliary assembly, and the top end portion of the output inductor winding is coplanar with the top surface of the auxiliary assembly.

29. The inductor assembly of claim 28, wherein the top surface of the auxiliary assembly is provided with a top end portion, and the top end portion is used for soldering and fixing and electrical connection to the external element.

30. The inductor assembly of claim 26, wherein a depth of the groove is greater than or equal to a thickness of the auxiliary assembly.

31. A single-stage power conversion device using a four-phase power circuit, comprising a circuit substrate and an adapter board; the circuit substrate and the adapter board both comprise an upper surface and a lower surface opposite to each other, and the lower surface of the circuit substrate is disposed adjacent to the upper surface of the adapter board; the upper surface of the circuit substrate has a first symmetry axis extending in an X-direction and a second symmetry axis extending in a Y-direction, and the circuit substrate is divided into a first region, a second region, a third region and a fourth region by the first symmetry axis and the second symmetry axis; the four regions are arranged clockwise according to the order of the first region, the second region, the fourth region and the third region; the first region is used for setting a first phase power circuit; the second region is used for setting a second phase power circuit; the third region is used for setting a third phase power circuit; the fourth region is used for setting a fourth phase power circuit;
The first phase power circuit and the second phase power circuit are arranged on one side of the first symmetry axis, and are symmetrically arranged along the second symmetry axis; the third phase power circuit and the fourth phase power circuit are arranged on the other side of the first symmetry axis, and are symmetrically arranged along the second symmetry axis; the first phase power circuit and the third phase power circuit are symmetrically arranged along the first symmetry axis, and the second phase power circuit and the fourth phase power circuit are symmetrically arranged along the first symmetry axis; the main circuit topology of the four-phase power circuit is the same.

32. The single-stage power conversion device of claim 31, wherein each of the four-phase power circuits comprises a primary-side sub-circuit and a secondary-side sub-circuit; the primary-side sub-circuit is a full-bridge circuit, and each secondary-side sub-circuit comprises two center-tap circuits electrically connected in parallel; each center-tap circuit comprises a synchronous rectifier switch, a secondary-side winding, and an output inductor.

33. The single-stage power conversion device of claim 32, wherein the primary-side sub-circuit comprises a primary-side winding, and the secondary-side sub-circuit comprises the secondary-side winding; the primary-side winding and the secondary-side winding of each of the four-phase power circuits are coupled in a same magnetic core to form a transformer; the circuit substrate includes a first transformer disposed in the first region, a second transformer disposed in the second region, a third transformer disposed in the third region, and a fourth transformer disposed in the fourth region.

34. The single-stage power conversion device of claim 33, wherein each primary-side sub-circuit comprises four primary-side switches, and wherein each transformer comprises a first side adjacent to the second symmetry axis, a third side opposite to the first side, a second side adjacent to the first symmetry axis, and a fourth side opposite to the second side; the four primary-side switches are disposed adjacent to the third side of the transformer, two primary-side switches of the four primary-side switches are disposed adjacent to the fourth side of the transformer, and the other two primary-side switches of the four primary-side switches are disposed adjacent to the second side of the transformer; and the synchronous rectifier switch in one center-tap circuit and the synchronous rectifier switch in the other central-tap circuit are respectively disposed on the second side and the fourth side of the transformer opposite to each other.

35. The single-stage power conversion device of claim 32, wherein the synchronous rectifier switches of the four-phase power circuit are arranged on the upper surface and the lower surface of the circuit substrate, and the output inductor is arranged on the lower surface of the circuit substrate; the projection of the synchronous rectifier switch arranged on the lower surface of the circuit substrate at least partially overlaps with the projection of the synchronous rectifier switch arranged on the upper surface of the circuit substrate on the upper surface, and is electrically connected in parallel by means of the circuit substrate; each output inductor comprises an inductor magnetic core and an inductor winding, and each inductor winding is passed through a central hole of the inductor magnetic core; and the synchronous rectifier switch is arranged in a gap between the inductor magnetic core and the circuit substrate.

36. The single-stage power conversion device of claim 35, wherein the synchronous rectifier switch in each center-tap circuit comprises two groups, and the inductor winding is arranged between the two groups of synchronous rectifier switches; an output terminal surface of each inductor winding is fixed and electrically connected to a pad provided on the upper surface of the adapter board, and an input end surface of each inductor winding is fixed and electrically connected to a pad provided on the lower surface of the circuit substrate.

37. The single-stage power conversion device of claim 32, wherein a synchronous rectifier switch of the four-phase power circuit is arranged on the lower surface of the circuit substrate, a grounding metal block is arranged between the synchronous rectifier switches arranged on the lower surface of the circuit substrate, and two ends of the grounding metal blocks are respectively fixed and electrically connected to the circuit substrate and the adapter board.
